(19) United States
(12) Patent Application Publication
(10) Pub. No.: US 2014/0338840 A1
(43) Pub. Date: Nov. 20, 2014

(54) Automated Label Application Device

(71) Applicant: NuLabel Technologies, Inc., East Providence, RI (US)

(72) Inventors: Benjamin David Lux, Providence, RI (US); Randy Peckham, North Scituate, RI (US); Jason A. Meek, Pawtucket, RI (US); Michael C. Woods, Rumford, RI (US); Andrew W. Marsella, Providence, RI (US)

(21) Appl. No.: 14/279,561

(22) Filed: May 16, 2014

Related U.S. Application Data
(60) Provisional application No. 61/824,413, filed on May 17, 2013.

(51) Int. Cl. B65C 9/14; B65C 3/08; B65C 9/04; B65C 9/10; B65C 9/00

(52) U.S. Cl. CPC B65C 9/14; B65C 9/10; B65C 9/0015; B65C 9/04; B65C 3/08; B65C 2009/0028; B65C 2009/0021
USPC 156/542; 156/578

(57) ABSTRACT

An apparatus and method is described herein for automatically labeling using labels having a fluid activatable adhesive along the back surface of the label. The apparatus includes a dispensing magazine for retaining a stack of labels, a first rotating transfer member, and an adhesive activation station aligned with the rotating transfer member. The dispensing magazine includes a dispensing end and a loading end. The first rotating transfer member is rotated in close proximity to the stack of labels and includes at least one belt having multiple openings for communication of suction to enable the belt to receive and releasably secure the front of the labels. The adhesive activation station is configured to apply to a fluid to the back of the labels to activate the adhesive such that the adhesive becomes tacky along the back surface of the label.

### CROSS-REFERENCE TO RELATED APPLICATIONS

This application claims priority to U.S. Application Ser. No. 61/824,413, filed on May 17, 2013 and entitled “AUTOMATED LABEL APPLICATION DEVICE,” the contents of which is hereby incorporated by reference in its entirety.

### TECHNICAL FIELD

An automated labeling apparatus and methods are described herein. More particularly an automated labeling apparatus and method for applying labels having fluid activatable adhesive onto containers, such as containers, cans, or jars is described herein.

### BACKGROUND

For over 50 years, automated machines have been used to apply labels onto containers, such as containers, cans, or jars. Typically, these machines utilize cold glue or hot melt adhesives, which are applied by a roller onto a pad prior to pick up and then transfer of a label onto another pad or drum which applies it to a container. Conventional automated labeling machines include those manufactured by Krones AG in Germany or Krones, Inc. in Franklin Wis. (Krones AG and Krones, Inc., being referred to herein as “Krones”). Other adhesives that have been used on such labeling machines include UV curable adhesives, which operate and are less tacky than cold glue or hot melt adhesives, until UV light is applied to the adhesive label. Although these adhesives are useful for their intended purpose, it has been found that applying tacky liquid adhesives prior to pickup of labels and throughout the label application process is undesirable as the liquid adhesives fall onto various parts of the machine creating a mess and can require excessive maintenance including machine downtimes to clean up the machine.

In addition to cold and hot glue applied labeling methods, preprinted pressure sensitive adhesive (PSA) labels are also used. These labels utilize a release liner to protect the preprinted label face from interacting with the tacky PSA. The use of traditional PSA labels results in several million pounds of waste per year in the bottling industry. PSAs also lack removability properties desirable in downstream recycling and container reusing facilities.

U.S. Pat. Nos. 6,306,242; 6,517,664; and U.S. Pat. No. 6,663,749 to Dronzek describe an additional example of a labeling apparatus for applying labels to plastic and glass containers. The labeling apparatus includes applying a layer of a hydrophilic solid material to a polymeric label to form a hydrophilic layer on said polymeric label; applying water, water containing a cross-linking agent or a water based adhesive over said hydrophilic layer to form a fastenable polymeric label; fastening said fastenable polymeric label to a glass, plastic or metal container or surface; and curing said polymeric label on said glass, plastic or metal surface or container. In this apparatus, the fluid contains functional chemical components in the form of solids suspended, dispersed, or dissolved in a liquid carrier.

### SUMMARY

An improved automated labeling apparatus and method for applying labels having a fluid activatable adhesive to containers (e.g., containers such as containers, cans, or jars) in which the labels are non-tacky until just before application to containers, thereby avoiding the use of tacky adhesives prior to pickup of labels and throughout the label application process and providing a cleaner running operation is described herein. The automated labeling apparatus and methods are compatible with labels having a variety of shapes and sizes including those with unusual shapes or cutouts. Further, the improved automated labeling apparatus and method provide an efficient transfer of labels from a stack of labels to a container, without the need to reorient or flip the label, by using vacuum belt and/or rotating wheel to releasably secure a single side of the label, e.g., only the front side of the label, such that the fluid activatable adhesive is exposed and accessible for application to containers. The use of a vacuum belt and/or rotating wheel configuration also allows the labels to be reliably secured in a rapid end-to-end sequence with the speed of the vacuum belt and/or rotating wheel being adjustable based on the container spacing at the labeling stage, thereby providing a more continuous operation of the labeling apparatus. The improved automated labeling apparatus and method is adaptable for use with new labeling machines or for retrofitting existing labeling machinery.

The details of one or more embodiments of the invention are set forth in the accompanying drawings and the description below. Other features, objects, and advantages of the invention will be apparent from the description and drawings, and from the claims.

In one aspect, an apparatus for use with labeling machinery includes a dispensing magazine for retaining a plurality of individual labels in a stack and an adhesive activation station aligned with at least a portion of a rotating transfer member. The dispensing magazine includes a dispensing end configured to dispense the individual labels. The loading end is configured to apply a force against the plurality of individual labels in the stack. The individual labels include a back surface having a fluid activatable adhesive that is non-tacky until activated and a front surface opposing the back surface. The first rotating transfer member rotates in close proximity to the individual labels and includes at least one belt thereon and is configured to apply to the back surface of the individual labels a fluid to activate the adhesive to become tacky along the back surface of the label. The at least one belt includes multiple openings for communication of suction to enable the transfer member to receive and releasably secure the front of the labels onto the at least one belt.

In another aspect, an apparatus for use with labeling machinery includes a dispensing magazine for retaining a plurality of individual labels in a stack, an actuating transfer member in close proximity to the individual labels and configured to move from a first position to a second position, a rotating transfer member positionable with respect to the actuating transfer member to receive the individual labels from the actuating transfer member, and an adhesive activation station aligned with at least a portion of the rotating transfer member. The dispensing magazine includes a dispensing end configured to dispense the individual labels and a loading end configured to apply a force against the plurality of individual labels in the stack. The individual labels include a back surface having a fluid activatable adhesive that is non-tacky until activated and a front surface opposing the back surface. The actuating transfer member is configured to contact the front surface of the individual labels at the second position. The actuating transfer member includes at least one belt thereon in which the at least one belt includes multiple openings for communication of suction to enable the actuating transfer member to receive and releasably secure the front surface of one of the labels onto the at least one belt at the second position. The rotating transfer member includes at least one belt thereon including multiple openings for communication of suction to enable the rotating transfer member to receive and releasably secure the front surface of the individual labels onto the at least one belt, and the adhesive activation station is configured to apply to the back surface of the individual labels a fluid to activate the adhesive to become tacky along the back surface of the label

In one aspect, an apparatus for use with labeling machinery includes a dispensing magazine for retaining a plurality of individual labels in a stack, a first rotating transfer member positionable with respect to the dispensing end to receive the dispensed individual labels, a second rotating transfer member in close proximity to the first rotating transfer member and including one or more arms extending from the perimeter of the first rotating member, and an adhesive activation station aligned with at least a portion of the second rotating transfer member. The dispensing magazine includes a dispensing end configured to dispense the individual labels and a loading end configured to apply a force against the plurality of individual labels in the stack. The individual labels include a back surface having a fluid activatable adhesive that is non-tacky until activated and a front surface opposing the back surface. The first rotating transfer member includes at least one belt thereon. The at least one belt includes multiple openings for communication of suction to enable the first rotating transfer member to receive and releasably secure the front surface of the individual labels onto the at least one belt. The adhesive activation station is also configured to apply to the back surface a fluid to activate the adhesive to become tacky along the back surface of the label.

In some implementations the first rotating transfer member further includes one or more valves, each of the valves being associated with a particular one of the multiple openings, to selectively control communication of suction to a selected subset of the multiple openings based on the size of the label.

In other implementations, the apparatus includes a container-handling device for receiving containers at an inlet, rotating the containers through a label application station, and directing the containers with the labels applied thereon to an outlet.

In some implementation, the apparatus includes an actuating transfer member connected to the dispensing end including a rotating end portion configured to contact the front surface of the individual labels and configured to move from a first position to a second position.

In other implementations, the movement of the actuating transfer member from a first position to a second position is configured to release the individual label from the dispensing end.

In some implementations, the dispensing magazine further includes paddle members attached to the loading end and configured to apply a force against the stack such that the stack assumes a bowed configuration and an edge of the label is released from the dispensing end.

In other implementations, the dispensing magazine is configured to partially restrain at least one of the individual labels such that at least one edge of the label is free of the dispensing magazine.

In some implementations, the dispensing end further includes a moveable retaining member, in which the movement of the retaining member is configured to release at least one edge of the label.

In other implementations, the front of the label is orientated substantially parallel to a surface of the at least one belt.

In some implementations, the apparatus includes a second rotating transfer element connected to the dispensing end being rotated in close proximity with the individual label.

In other implementations, a rotation of the second rotating member is configured to release the individual label from the dispensing end.

In some implementations, the apparatus includes a plurality of rollers disposed between the first rotating transfer element and the dispensing magazine.

In some implementations, the apparatus further includes a container-handling device for receiving containers at an inlet, rotating the containers through a label application station, and directing the containers with the labels applied thereon to an outlet.

In other implementations, any of the rotating transfer member and the actuating transfer member further includes one or more valves, each of the valves being associated with a particular one of the multiple openings, to selectively control communication of suction to a selected subset of the multiple openings based on the size of the label.

In some implementations, the movement of the actuating transfer member from a first position to a second position is configured to release the individual label from the dispensing end.

In other implementations, the front of the label is orientated substantially parallel to a surface of the at least one belt.

In some implementations, the actuating transfer member is configured to accommodate a plurality the individual labels.

In other implementations, the actuating transfer member is configured to contact the rotating transfer member at the first position and the second position.

In some implementations, any of the second rotating transfer member and the first rotating transfer member further include one or more valves, each of the valves being associated with a particular one of the multiple openings, to selectively control communication of suction to a selected subset of the multiple openings based on the size of the label.

In other implementations, the one or more arms are rotatable to contact the individual labels.

In some implementations, the first rotating transfer member comprises two or more belts configured with a gap there between.

In other implementations, the one or more arms are rotatable to contact the individual labels through the gap.

In some implementations, the one or more arms include multiple openings for communication of suction to enable the second rotating transfer member to receive and releasably secure the front surface of the individual labels onto the one or more arms.

In other implementations, the one or more arms include a compliant material.

In some implementations, the one or more arms include Vinyl, Polyurethane, Nitrile, Silicone, or other soft rubber.

In other implementations, the one or more arms are arranged in a pinwheel configuration.

In some implementations, the one or more arms include a curved portion.

In other implementations, the one or more arms are rotatable to deform the first rotating transfer member into contact with the individual labels.

In other implementations, the apparatus further includes a plate disposed between the first rotating transfer member and the second rotating transfer member, in which the one or more arms are rotatable to contact the plate such that the plate deforms the first rotating transfer member into contact with the individual labels.

In some implementations, the plate and the individual labels are similarly sized.

In other implementations, the plate is flat.

In some implementations, the plate is contoured.

In other implementations, the at least one belt of the actuating transfer member and the at least one belt of the rotating transfer member are configured to form a continuous belt path.

In some implementations, the non-adhesive activating fluid is a solvent.

In other implementations, the individual label is removed from the dispensing magazine without the use of a viscous adhesive material.

In some implementations, the second rotary transfer member is configured to transfer the individual label through a label application station.

Other aspects, features, and advantages will be apparent from the description and drawings, and from the claims.

### DESCRIPTION OF DRAWINGS

The foregoing and other objects, features, and advantages of the invention will become more apparent from a reading of the following description in connection with the accompanying drawings in which:

FIG. 1 is a schematic view illustrating a labeling apparatus.

FIG. 2A is a perspective view of the magazine of FIG. 1.

FIG. 2B is another perspective view of the magazine of FIG. 1.

FIG. 3 is cross-sectional view of one of the labels of FIG. 1.

FIG. 4 is a schematic view illustrating a labeling apparatus.

FIG. 5A is a perspective view of a magazine and transfer member used in the labeling apparatus of FIG. 4.

FIG. 5B is a perspective view of another magazine and another transfer member used in the labeling apparatus of FIG. 4.

FIG. 6 is a schematic view illustrating a labeling apparatus.

FIG. 7A is a perspective view of a magazine of FIG. 6.

FIG. 7B is a perspective view of a magazine having a rotating member mounted thereon.

FIG. 7C is a perspective view of a magazine, a series of rollers with labels retained between the rollers, and a rotating transfer member including a vacuum belt.

FIG. 8 is a schematic view illustrating a labeling apparatus.

FIG. 9 is a perspective view of a magazine, a first rotating transfer member including two vacuum belt portions, and a second rotating transfer member.

FIG. 10A is a schematic view illustrating a labeling apparatus.

FIG. 10B is another schematic view illustrating a labeling apparatus shown in FIG. 10A.

FIG. 11 is a perspective view of a magazine, a first rotating transfer member, a second rotating transfer member, and an actuating transfer member.

FIG. 12 is another perspective view of the magazine, the first rotating transfer member, the second rotating transfer member, and the actuating transfer member FIG. 11.

FIG. 13 is a schematic view illustrating a labeling apparatus.

FIG. 14 is a perspective view of a magazine, an actuating transfer member, and a rotating transfer member of FIG. 13.

FIG. 15 is another perspective view of the magazine, the actuating transfer member, and the rotating transfer member of FIG. 13.

FIG. 16 is a schematic view illustrating a labeling apparatus.

FIG. 17 is a perspective view of a magazine, a first rotating transfer member including two vacuum belt portions, and a second rotating transfer member.

### DETAILED DESCRIPTION

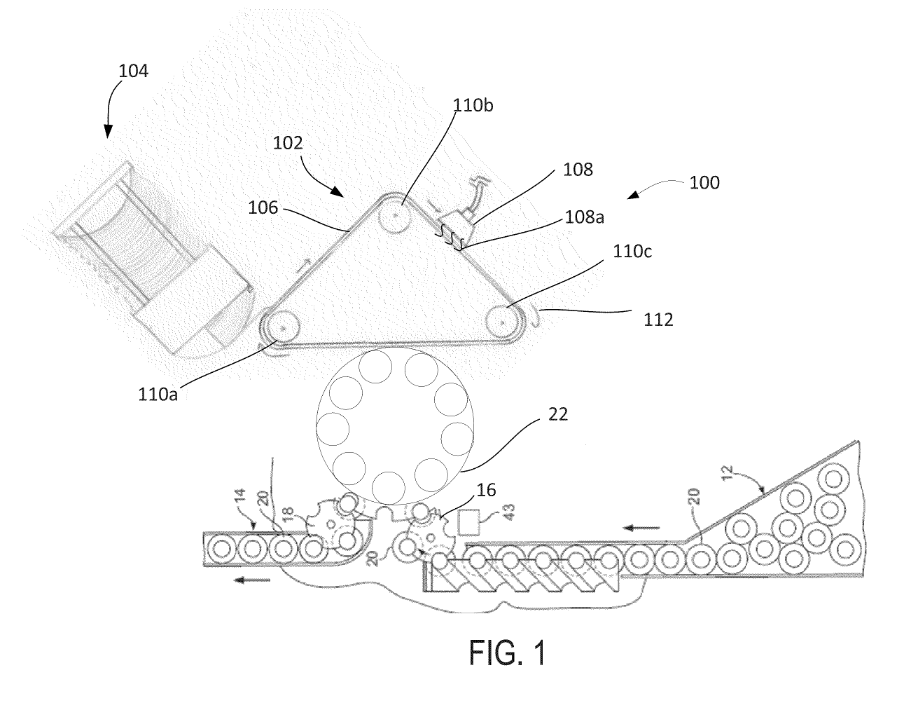

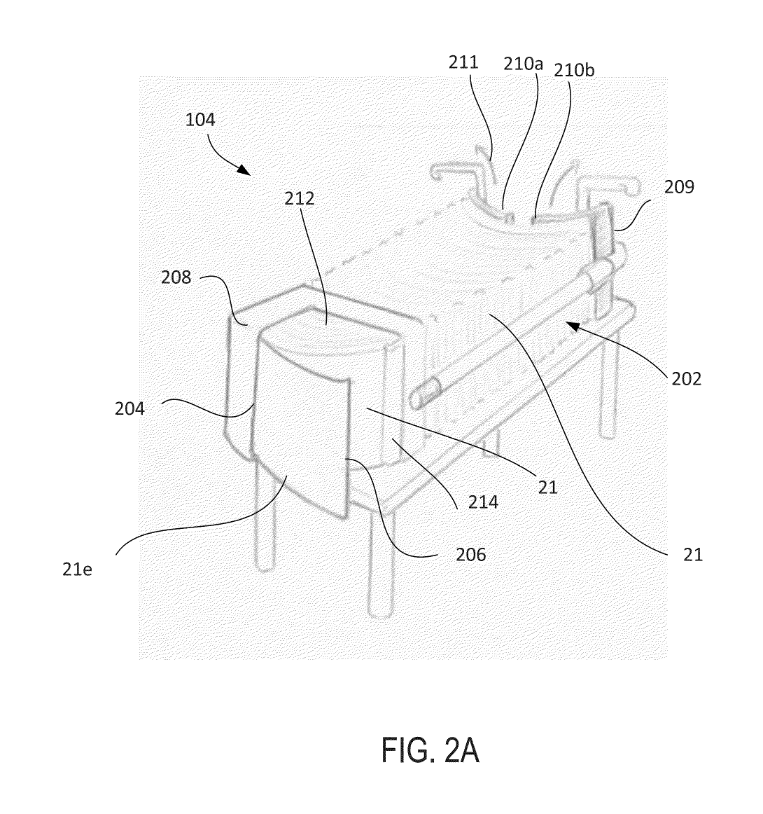

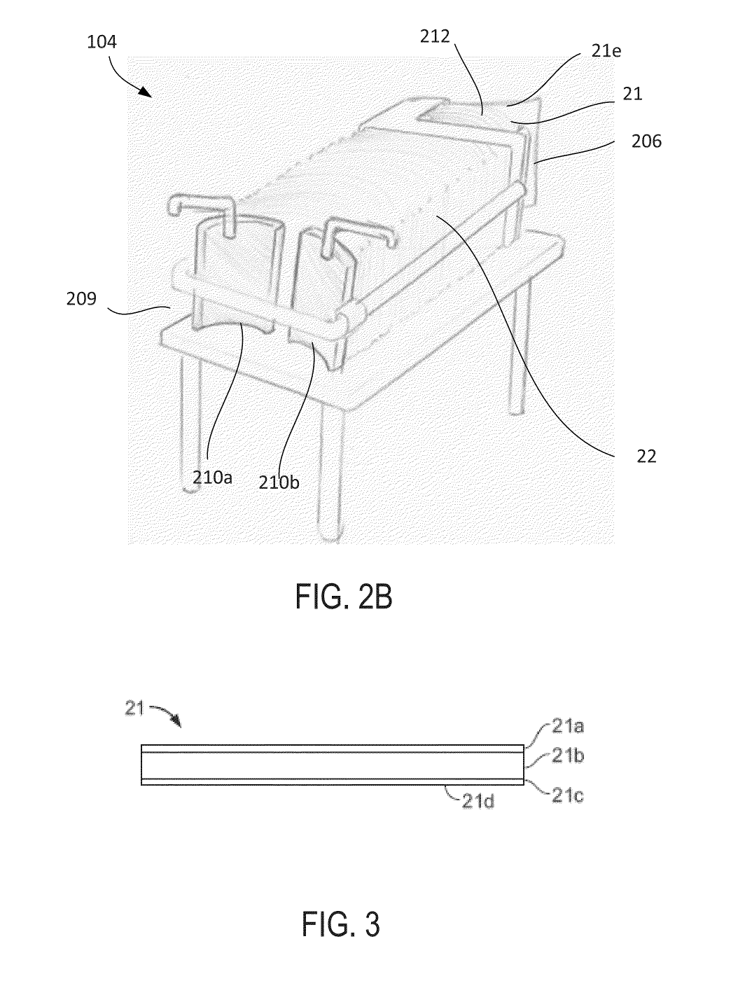

Referring to FIGS. 1, 2A, and 2B, an apparatus 100 for automatically applying labels to containers is shown. Apparatus 100 employs container-handling mechanisms including an inlet conveyor section 12, an outlet conveyor section 14, an inlet-rotating platform 16 for transferring containers 20 from the inlet conveyor section to a rotating platform or turret 22, and an outlet-rotating platform 18 for removing containers 20 from the rotating turret 22 to the outlet conveyor section 14 after the containers have been labeled.

It should be understood that the construction of the inlet conveyor section 12, the outlet conveyor section 14, the inlet-rotating platform 16, the outlet-rotating platform 18, and the rotating turret 22 would be apparent to one of ordinary skill in the art. For example, Krones manufactures a line of rotary labeling equipment including the inlet conveyor section 12, the outlet conveyor section 14, the rotating container-transfer members 16 and 18, and the rotating turret 22 of the type that can be employed in the present systems and methods. Therefore, a detailed discussion of these features is not required herein.

In one example, the apparatus 100 includes a transfer device 102 used to transfer a label from a magazine 104, e.g., a dispensing magazine, that retains a plurality of pre-cut labels to the containers 20. More particularly, during use, the transfer device 102 uses a belt 106 to remove a non-activated label from the magazine 104. The belt 106 is a porous belt, e.g., includes multiple openings, in communication with a vacuum chamber. In some examples, the belt 106 includes a hollow core or inner conduit, such that the pores are interconnected. Thus, vacuum applied to one region can transmit to the entire belt. The belt rotates around a vacuum chamber such that an object, e.g., a precut label, applied to the face of the belt is secured to the belt 106 during rotation of the belt 106 by a continued application of the vacuum. In some examples, the vacuum applied to the belt, via one or more vacuum chambers positioned against the porous surface of the belt, through the pores that are temporarily in contact with the vacuum chamber as the belt advances. While, in at least some of the examples described herein, the belts includes a vacuum supply mechanism provided along the belt, e.g., vacuum generators along the backside of the belt, the vacuum generator can be located remotely from the belt. For example, the vacuum generator can be located at a distance from the rotating platform or turret 22. In some examples, the belt 106 includes one or more valves that are associated with a particular one of the multiple openings that can selectively control communication of suction to a selected subset of the multiple openings based on the size of the label. In some examples, the belt pores and/or multiple openings can be sized to apply sufficient label handling force with the minimum amount of open area (e.g., combined porosity) to minimize vacuum flow.

In some examples, the applied vacuum applied is approximately 10 inHG. In other examples, the applied vacuum is adjustable to identify the optimal level of vacuum to remove an individual label reliably from the label stack (without pulling out multiple labels), and apply the label to the container without partially or fully preventing the label from properly adhering to the container, e.g., because of an excessive applied vacuum during label application.

In some examples, the belt 106 is formed of an elastomeric material. For example, the elastomeric material can be formed of vinyl, polyurethane, nitrile, silicone, or other soft rubber. The flexibility of the belt material permits the belt 106 to flex and conform to a shape of the containers 20. This conformation serves to batten down the labels during labeling (as described below). Other suitable materials can be used, for example, a fabric material, a sponge material, a rubber material, and so forth. In some examples, the belt 106 can include a chain of rigid metal or plastic narrow elements or links. In other examples, the belt 106 can be modular, e.g., include one or more belts connected in series, such that at least one of the belts can conform individually to the shape of the container 20. The belt movement is provided by a cam drive arrangement using cams 110a-c rotating in a direction represented by, for example, the arrow 112. While the cams 110a-c and the belt 106 are shown in a triangular configuration, other configurations may be used. For example, the belt 106 can be arranged in any manner such that the belt travels from the magazine 104 to an adhesive activation station 108 to the rotating turret 22. In this example, the path followed by the belt 106 can be linear. Exemplary cam drive arrangements for rotating a transfer member are known to those skilled in the art.

As shown in FIGS. 2A and 2B, the magazine 104 retains a plurality of pre-cut individual labels, e.g., a label stack 202, within the body of the magazine 104 between a dispensing end 208 and a loading end 209 including one or more paddle members 210a-b. The magazine 104 retains the labels such that the front-most label 21e in the label stack 202 is partially restrained by the magazine 104 at the dispensing end 208 and presented to the transfer device 102. For example, label 21 is restrained by the magazine at first edge 204 while a second edge 206 is free of the magazine 104. In some examples, the release of the second edge 206 is caused by a temporary retraction of a retaining member 214 that is moveable. In this example, the retaining member 214 can be configured to periodically retract, e.g., in time with the pace of labeling of the apparatus. In some examples, the retaining edge can be mechanically driven in an oscillating motion axially along the length of the label stack, with a wedge-like edge geometry that flicks a single label outwards on the return stroke of motion. In other examples, the retaining member can be a rotating element or rod with a wedge-like feature that flicks the leading label outwards. In other examples, the label stack 202 is contacted and compressed towards the dispensing end. As this compression releases, the stack expands and the force of the expansion causes the bottom label of the stack, i.e., the label closest to the dispensing end, to overcome the force keeping the retaining member 214 in place. In this example, the retaining member 214 is retracted and the second edge 206 is released from the magazine 104. In other examples, the front-most label 21e in the label stack 202 is contacted such that the label moves thereby rendering the retainer member ineffective.

In some examples, an entire surface of the label 21 is presented to the transfer device 102. For example, the label 21 is ejected or dispensed from the magazine 104. The close proximity of the transfer device 102 to the magazine 104 ensures that the vacuum of the belt 106 adheres the front side of the label 21 and secures the front side of the label 21 to the belt 106.

In some examples, the one or more paddle members 210a-b are configured to apply a force against a center of the label stack 202 such that the label stack 202 assumes a contoured or bowed 212 shape that propagates throughout the stack. In some examples, the one or more paddle members 210a-b are shaped with an arcuate surface. In this example, the arcuate surface is optimized to induce an effective bend to the stack, thereby promoting the front-most label to ‘flick’ outwards easily, without inducing any crease or fixed bend into the labels. In some examples, the one or more paddle members 210a-b includes a spring. For example, the paddles are hinged, and spring-loaded to pivot inwards around the hinge axis. Thus, the one or more paddle members 210a-b is restricted to rotate outwards (e.g., away from the label stack). This restricted rotation permits replacement labels to be pushed through the hinged paddle members 210a-b from the back of the label stack (e.g., the loading end), while forward pressure is continuously applied to the stack. The paddle members 210a-b are further mounted to a spring-loaded carriage that provides a continuous force against the back of the label stack, pushing the entire stack towards the label dispensing mechanisms.

The force applied by the one or more paddle members 210a-b can be adjusted based on the properties for the labels being used. For example, the one or more paddle members 210a-b can be configured to apply a greater force to thicker labels to achieve a contoured stack. In some examples, the force applied by the one or more paddle members 210a-b is equal. In other examples, one of the one or more paddle members 210a-b can be configured to apply a greater force than the remaining paddle. Using two paddles allows one paddle to be moved out of the way when loading additional labels while the other keeps the attack loaded. The removed paddle can be placed behind the newly loaded labels. After loading, the second paddle can be moved to the back of the stack also.

For each of the examples described herein, the label 21 (e.g., media) can include a printable layer 21a formed on the front side of a stock, media, or facesheet 21b on a front side of the label 21, and a back side 21c on a back side of the label 21 with a solvent (fluid) sensitive adhesive agent layer 21d (such as a polymer type adhesive) which possesses no tack in its dry or non-activated state as shown in, e.g., FIG. 3. Layer 21d enables label 21 to become tacky along the back side 21c once the solvent (fluid) sensitive adhesive agent layer 21d becomes tacky upon application of activating fluid when supplied at adhesive activation station 108, as described later below. In some examples, the solvent is non-adhesive. This enables the label once its adhesive is activated to adhere along its back surface to a variety of article surfaces, such as paper, cardboard, metal, as well as glass and plastics. In the example of FIGS. 1-2B, the containers 20 in the case of containers may be glass or plastic. Exemplary liner-free labels and activating fluid are described in U.S. Pat. No. 8,334,336 titled “Fluid Activatable Adhesives and Fluids for Activating Same for Use with Liner-Free Labels” and U.S. Pat. No. 8,334,335 titled “Fluid Activatable Adhesives and Fluids for Activating Same for Use with Liner-Free Labels,” the contents of each of which are hereby incorporated by reference in their entirety. The printable layer 21a may be a preprinted layer of ink(s) providing the desired label for the container 20 as typical of labels applied to containers. Typically, the labels in the magazine, e.g., the magazine 104, are identical for a given set of container 20 being processed by the apparatuses described herein.

As shown in FIG. 1 and other examples described herein, the adhesive activation station 108 has one or more fluid dispensing mechanisms (e.g., such as one or more sprayers 108a) for application of pressurized adhesive activation fluid onto labels 21. The activation station can be located along the belt 106 at any point between the magazine 104 and the rotating turret 22. In some examples, the adhesive activation station 108 is located in close proximity to the magazine 104 to provide a maximum activation time before the label is applied to the container 20. The activation fluid can be a combination of one or more solvents, such as water and/or low boiling point alcohols. In some examples, the activation fluid does not contain any suspended or dissolved solids in the liquid (e.g., the fluid is a blend of one or more neat drying solvents and/or water) and only contains solvents. In some examples, the solvents can have low enough vapor pressures to evaporate in room temperature environmental conditions. By including no suspended solids in the activation fluid and utilizing volatile solvents, any liquid that is released and not applied to the labels (overspray) will dry clean thereby reducing cleanup and maintenance of the apparatus 100. Each of the one or more sprayers 108a may be a nozzle with a valve that is held in a fixture (not shown). The nozzle's valve is actuated to apply fluid to wet label 21 as it moves through the adhesive activation station 108. Timing of spraying of fluid for different run speeds of apparatus 100 is enabled by a control system. For example, the nozzle of the one or more sprayers 108a may be an air-assisted nozzle. However, any sprayer mechanism may be used may be used so that adequate fluid is sprayed on layer 21 as moves with respect to the adhesive activation station 108. For example, the fluid dispensing mechanisms can include an array of one or multiple fan or cone nozzles controlled by valves, an array of one or multiple air-assisted fan or cone nozzles controlled by valves, and/or an inkjet-type spray head.

Each of one or more sprayers 108a provides a fan pattern aligned with the height of the label 21. Thus, the activation fluid is provided directly from the one or more sprayers 108a onto the label. Preferably, the one or more sprayers 108a, include multiple sprayers, e.g., such as two, for spraying fluid are provided to obtain the desire surface coverage of the label with fluid as it moves through the adhesive activation station 108. In one particular example, when two nozzles are used, each nozzle produces at or approximately 2 inch fan when incident the label, and together they activate a label which is 4 inches in height to deliver a uniform layer of fluid. The multiple sprayers are aligned in a vertical dimension parallel to the height of label 21, where the sprayers are at a distance from the label 21 to direct coverage of the entire back (or at least substantially the entire back such as greater than 90% of the back surface) of the label 21 to assure label adhesion at the rotating turret 22. The flow rate out of the nozzle is variable depending on label speed to produce a desired fluid deposition rate, such as 0.15 g per 24 square inches. In another example, the one or more sprayers 108a includes one sprayer 108a that provides a spray pattern aligned with the height of the label. In some examples, overspray can be minimized by timing spray to correspond with the presentation of a label. In other examples, a blower or wiper can be directed towards the belt after the label is applied to the container. The blower or wiper is configured to remove excess activation fluid on the belt 106 so that residual activation fluid does not impact the securement of a new label. For example, a blower can be located on belt 106 after the rotating turret 22 but before the magazine 104.

In this manner, the belt 106 directs the labels held upon the belt 106 through an adhesive activation station 108 to apply a fluid for activating adhesive along the label's back surface 21c to change its layer 21d from a non-tacky state to a tacky state just before application of the label to a container at the rotating turret 22 (e.g., at an application station). For example, the fluid activatable adhesive is only tacky to permit the label to be adhered to the outer surface of a container at a location in proximity to the adhesive activation station 108.

Each of the labels 21 is applied essentially at its midline to the periphery of the container 20, thereby providing outer wings extending in opposed directions from the centerline of the label, which is adhered to the container. In some examples, a pad (not shown) or the belt 106 is actuated forward by a cam mechanism at the rotating turret 22 with respect to container 20 to transfer the label from the belt 106 and/or pad. As the belt and/or pad is often made of flexible or deformable material, such as rubber foam, vinyl, polyurethane, nitrile, silicone, or other soft rubber, the belt and/or pad deforms in response to the contact of the container. Thus, the belt and/or pad assist in joining the container outer surface to label by its activated adhesive. However, the labels can be applied to the outer surface of the containers in other ways. When the amount of tack on the label 21 after label activation at rotating turret 22 is less than traditionally used cold glue or hot melt adhesive, the amount of deformation can be increased to assist in joining the container outer surface to label by its activated adhesive as well as increasing the level of wraparound of the label to container 20. The amount of deformation can be adjusted by increasing the forward actuation of the belt and/or pad with respect to container 20 at the rotating turret 22. The forward movement of the belt and/or pad is timed with position container 20 in the rotating turret 22 based in parts on the rotation of the turret 22 and/or the belt 106. In some examples, the belt 106 described above includes a plate, e.g., a concave firm surface, on the opposing side of a label. In some examples, the concavity of the plate corresponds to the shape of the containers to be labeled. In this way, the plate can assist in joining the label to the container.

After the labels 21 have been effectively adhered to the containers 20, the containers are carried by the rotating turret 22 to the container-transfer member 18, at which point the containers are transferred to the outlet conveyor section 14 for subsequent packaging.

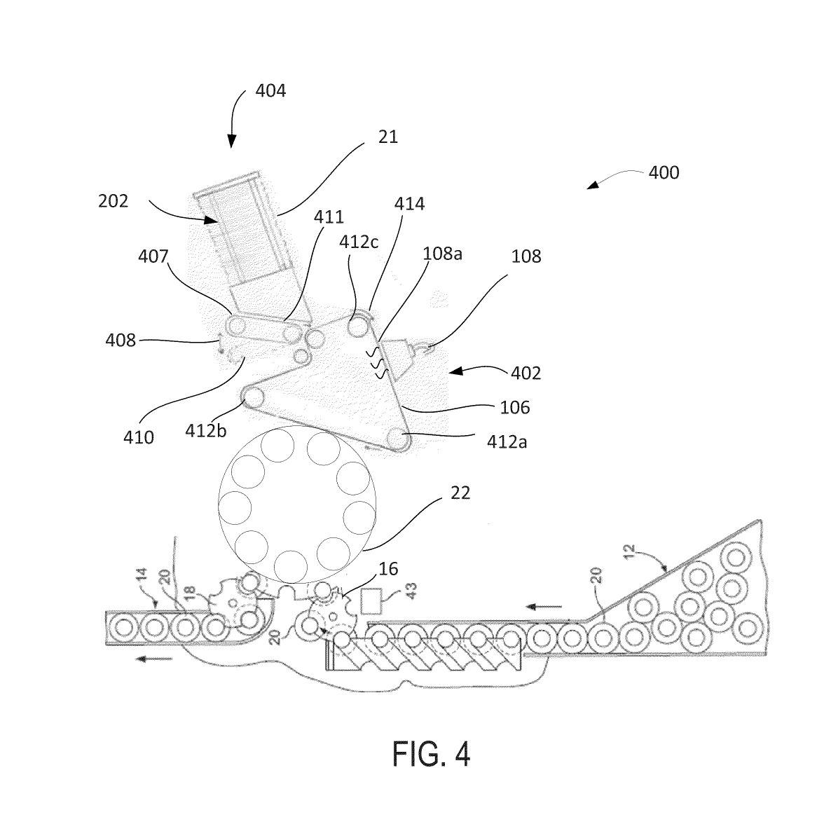

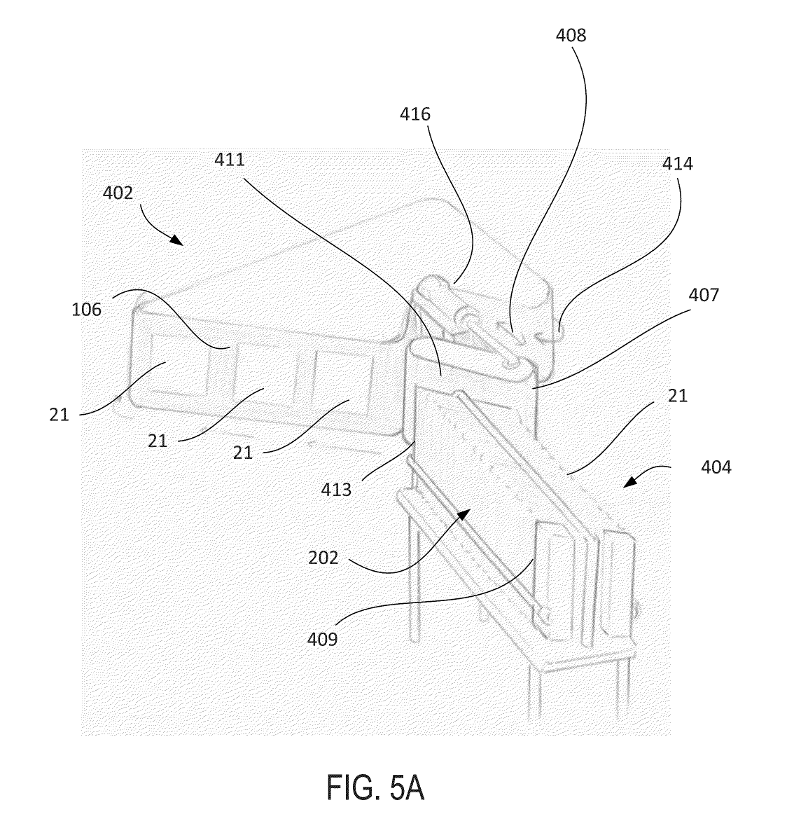

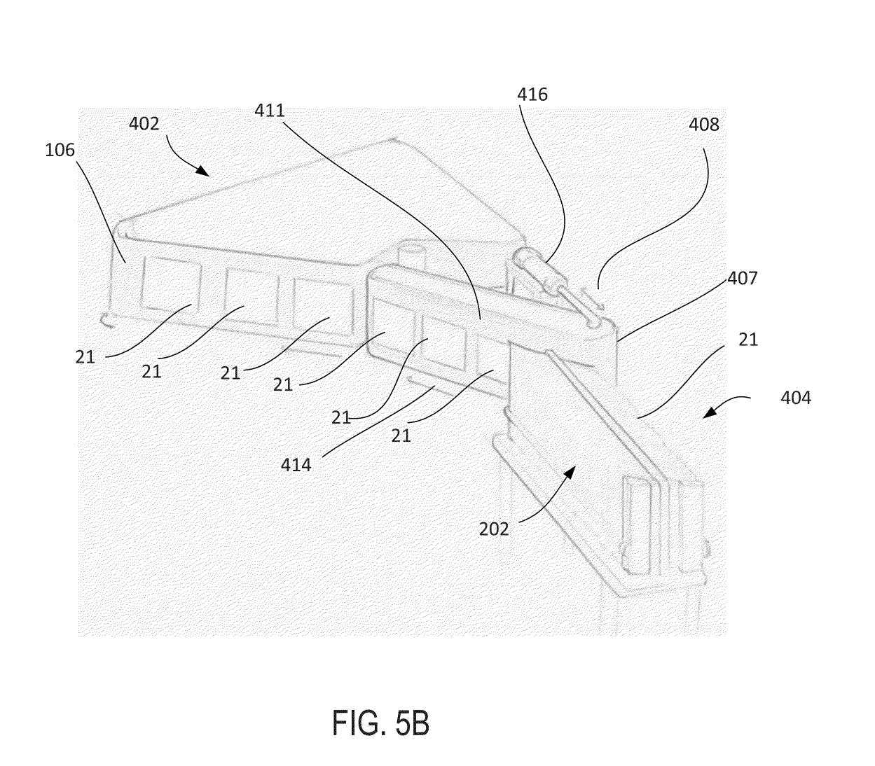

Referring to FIGS. 4-5B, the apparatus 400 includes a transfer device 402 used to transfer a label from a magazine 404, e.g., a dispensing magazine, that retains a plurality of pre-cut individual labels, e.g., a label stack 202, to the containers 20. More particularly, during use, the transfer device 402 uses an actuating-actuating-transfer member 407 having a first belt 411 to remove a non-activated label from the magazine 404 and the belt 106 to transfer the label through the adhesive activation station 108 to the surface of the containers 20. The features of the first belt 411 are as generally described with respect to the belt 106. In some examples, a portion of the first belt 411 is in contact with the belt 106 such that the first belt 411 to the belt 106 contact creates a continuous belt path and ensures a smooth label transfer there between. In other words, at least a portion of the front side of the label 21 remains secured to the first belt 411 until the vacuum of the belt 106 secures at least a portion of the front side of the label 21. In other examples, the belt 411 is in close proximity, but not touching, the belt 106. In this case, while at least a portion of the front side of the label 21 remains secured to the first belt 411, the remaining unsecured portions of the label 21 are incrementally engaged by the vacuum of the belt 106 until the label 21 is free of the first belt 411 and secured to the belt 106. The distance between the first belt 411 and the belt 106 could be no greater than the width of the label 21. In some examples, the distance between the first belt 411 and the belt 106 is less than about 1 inch.

As described above, the first belt 411 and/or the belt can be a porous belt that rotates around a vacuum chamber such that an object, e.g., a precut label, applied to a face of the belt is secured to the belt 106 during rotation of the belt 106 by a continued application of the vacuum. In some examples, the belt 411 is sized such that one label can fit on the actuating-transfer member 407, as generally shown in FIG. 5A. In other examples, the belt 411 is sized such that more than one label can fit on the transfer member, e.g., at least 2 labels, at least 3 labels, at least 4 labels, at least 5 labels, and so forth, as shown in FIG. 5B. Generally, the number of labels on the actuating-transfer member 407 is proportional to the length of the actuating-transfer member 407 and/or the configuration of the vacuum chamber. In some examples, the application of the vacuum is controlled via the valve mechanisms associated with each of the openings. In this case, the area of the belt 106, 411 capable of securing the label can generally resemble the shape of the labels.

As shown in FIGS. 4-5B, a magazine 404, e.g., a dispensing magazine, retains a plurality of pre-cut individual labels, e.g., a label stack 202, within the body of the magazine 404 between the dispensing end 413 and the loading end 409 such that a front-most label 21e in the label stack 202 is presented to the actuating-transfer member 407 of a transfer device 402. The magazine 404 is configured to present an individual label, e.g., the front-most label 21e, by canting the label at an angle substantially parallel to the longitudinal axis of the actuating-transfer member 407 as transfer device comes into contact with the magazine 404. For example, the angle between the front of the label and the actuating-transfer member 407 can be less than about 90°, e.g., less than about 80°, less than about 70°, less than about 60°, less than about 50°, less than about 40°, less than about 30°, less than about 20°, less than about 15°, less than about 10°, less than about 5°, and so forth. The actuating-transfer member 407 travels along a direction represented by, for example, the arrow 408 from a pick-up position in contact with the magazine 404 (as shown in FIG. 4) to a second position 410. In some examples, a motorized arm 416 causes the movement of the actuating-transfer member 407. For example, the motorized arm could be an air cylinder or an electric actuator.

At the pick-up position, the close proximity of the transfer device 402 to the magazine 404 ensures that the vacuum of the belt 411 adheres and secures the front side of the label 21 to the belt 411 by a continued application of the vacuum to the label 21. As the label 21 is secured to the actuating-transfer member 407, the belt 411 can begin rotating in a direction towards the belt 106 represented by, for example, the arrow 414.

In some examples, at the second position 410, the movement of the actuating-transfer member 407 away from the magazine 404 separates an individual label, e.g., the front-most label 21e, from the label stack 202. In other examples, the movement of the rotation of the actuating-transfer member 407 separates the individual label, e.g., the front-most label 21e, from the label stack 202.

In some examples, once the actuating-transfer member 407 has secured at least one label thereon, the actuating-transfer member 407 retracts towards the transfer device 401, e.g., in the direction of arrow 408, and contact is made with the belt 106. In this example, the first belt 411 and the belt 106 can rotate in the same direction, and the label 21 securely transfers from actuating-transfer member 407 to the belt 106. In this example, both the first belt 411 and the belt 106 secure the front side of the label 21 such that the fluid activatable adhesive is exposed. As shown in FIG. 5A, for example, a plurality of labels 21 can be consistently and/or continuously secured in a uniform end-to-end manner.

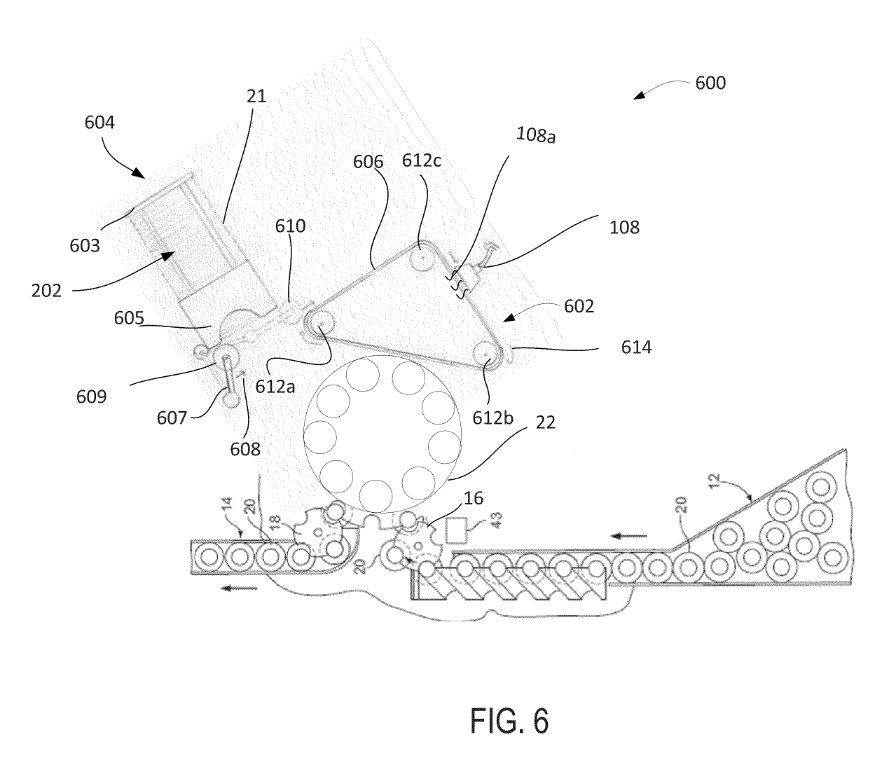

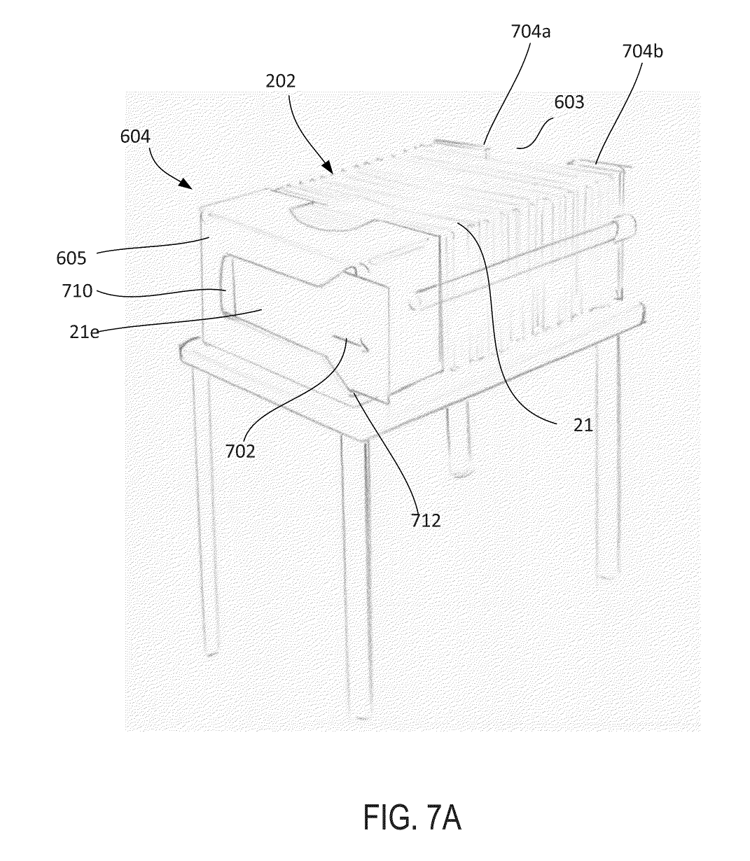

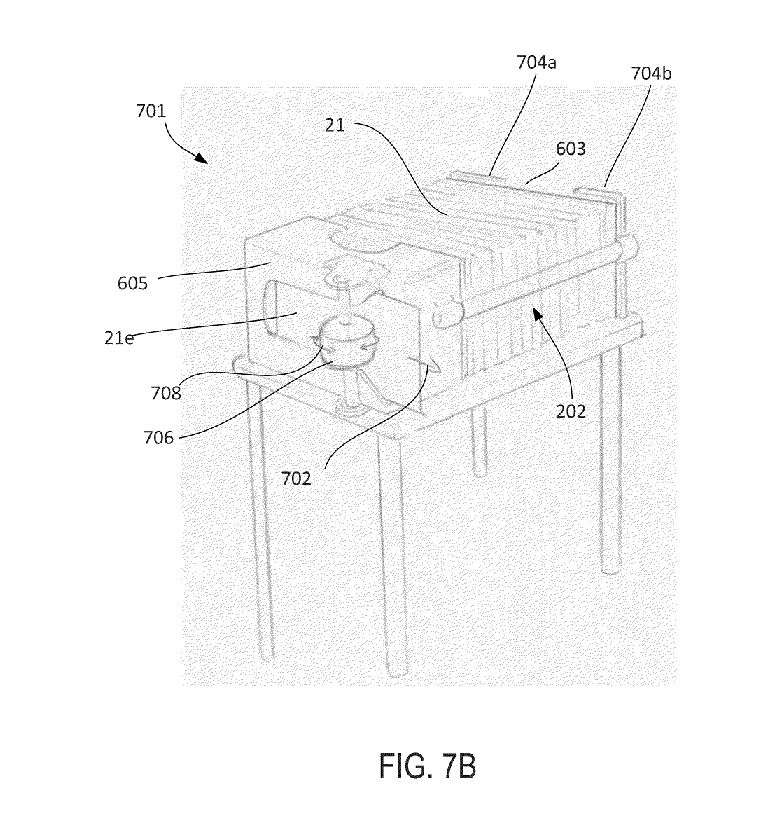

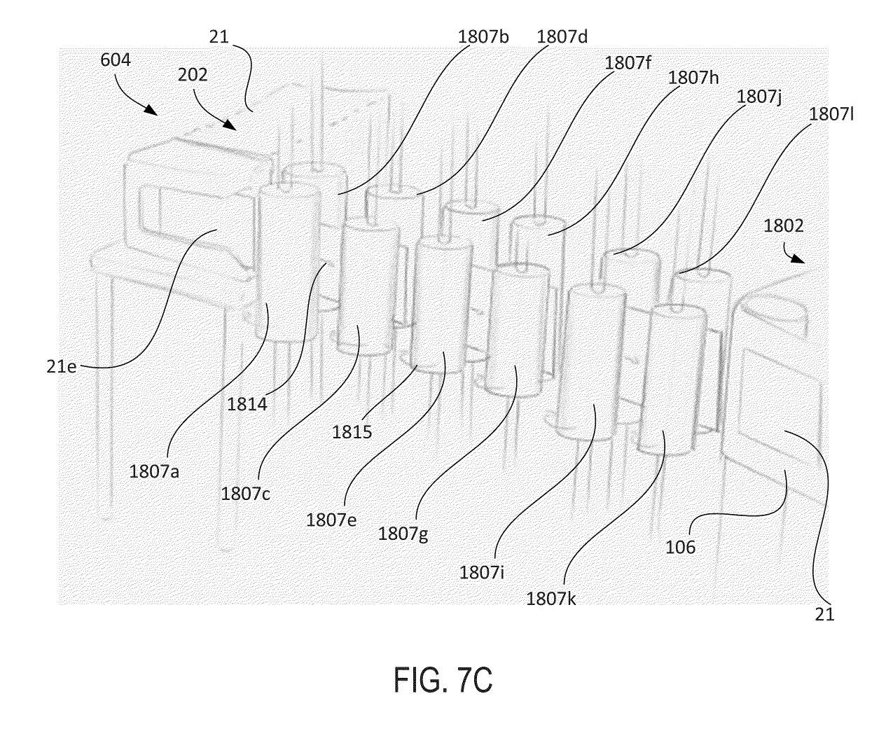

Referring to FIGS. 6-7A, the apparatus 600 includes an actuated transfer device 602 used to transfer a label from a magazine 604, e.g., a dispensing magazine, to the transfer device 602. The magazine 604 retains a plurality of pre-cut individual labels, e.g., a label stack 202, between a dispensing end 605 and the loading end 603. More particularly, the magazine includes an actuated transfer member 607 having a rotating end portion 609. In some examples, the rotating end portion 609 is a roller or spinning element. The transfer device 602 uses a transfer the belt 106 to transfer a non-activated label from the actuated transfer member 607 through the adhesive activation station 108 to the surface of the containers 20. In this example, the actuated transfer member 607 is activated and travels along a direction represented by, for example, the arrow 608 from a first position (as primarily shown in FIG. 6) to a second position 610. As the devices moves, the rotating end portion 609 contacts the label. This contact causes the label 21 to dispense from the magazine 604 in the direction shown generally as an arrow 702. The magazine 604 and transfer device 602 are located in close proximity such that the transfer device 602 secures the front side of the label 21 to the belt 406 as the label exits the magazine 604.

In some examples, the rotating end portion 609 is beneficial to advancing the front-most label 21e. In other examples, the end of transfer member 607 includes a roller with limited or single-direction rotation (i.e. Pushes the label laterally into the belt, and then rolls backwards over the next label to reset it's feeding motion), or a non-rolling ‘wiper’ or wedge-shaped lip that applies greater lateral force to the front labels in the direction of the handoff to the belt, and less force as the member retracts over the next label.

In some examples, a motor causes the movement of the actuated transfer member 607. For example, the motorized arm could be an air cylinder or an electric actuator. The frequency of this actuation can be configured to provide an adjustable and/or desired rate of labels based on the number and/or rate of containers to be labeled and/or for improved accuracy of placement on the belt 106.

Referring to FIG. 7A, in some examples, the magazine 604 includes at least one spring-loaded member 704a-b that compresses the label stack 202 against the dispensing end 605. In this example, the dispensing end 605 includes a slot 710 and an opening 712 to facilitate removal of an individual label from the magazine 604. The slot 710 is configured to provide a window along at least a portion of the width of the magazine such that at least a portion of the label 21 is exposed to the transfer member 607. In some examples, the height of the slot corresponds to about 90% of the label height, e.g., about 80%, about 70%, about 60%, about 50%, about 40%, about 30%, about 20%, about 10%, and so forth. In other examples, the length of the slot corresponds to about 90% of the label length, e.g., about 80%, about 70%, about 60%, about 50%, about 40%, about 30%, about 20%, about 10%, and so forth. The opening 712 at the side of the dispensing end 605 is configured such that the labels can exit the magazine 604 after contact with a transfer mechanism. The individual label, e.g., the front-most label 21e, from the label stack 202 is presented to the transfer member 607 (not shown) through the slot 710. As the transfer member 607 travels along a direction a direction represented by, for example, the arrow 608 from a first position in contact with the magazine 604 to a second position 610 (as shown in FIG. 6), the individual label, e.g., the front-most label 21e, from the label stack 202 exits the magazine along a direction represented by, for example, an arrow 702.

Again referring to FIG. 6, the close proximity of the transfer device 602 to the magazine 604 ensures that as the individual label, e.g., the front-most label 21e, from the label stack 202 exits the magazine, the label contacts the belt 106. The vacuum of the belt 106 secures the front side of the label to the belt for further transport. In some examples, the movement of the transfer member 607 away from the magazine 604 separates the individual label, e.g., the front-most label 21e, from the label stack 202 from the label stack 202. In other examples, the movement of the transfer member 607 away from the magazine 604 partially separates the individual label, e.g., the front-most label 21e, from the label stack 202 and a movement of the belt 106 completes the separation.

Referring to FIG. 7A, the magazine 604 is shown without the actuated transfer member 607. In this example, the label stack 202 can be orientated at a slight angle towards the direction of dispensation. The spring loaded members 704a-b can apply a force against the stack such that the stack retains this angular configuration and remains compressed against the dispensing end. The force applied by the end members can be adjusted, e.g., to address differences in label thickness, size, and/or adjust the number of labels simultaneously dispensed by magazine 604. In some examples, by angling the front of the magazine, the force applied to the label stack is greater in a ‘shear’ or lateral direction than in the normal or axial direction. This configuration facilitates feeding the leading edge of the front-most label.

In some examples, the magazine can include a transfer element in addition to or in place of the transfer member 607. For example, as shown in FIG. 7B, a magazine 701, e.g., a dispensing magazine, can include a rotatable element 706 having protrusions or bumps 708 attached to the dispensing end 605 of the magazine 701. In this case, the label 21 is presented to the rotatable element 706 such that the protrusions or bumps 708 are in contact with the label 21. The transfer element rotates about its axis thereby causing the individual label, e.g., the front-most label 21e, from the label stack 202 to exit the magazine along a direction represented by, for example, an arrow 702. The protrusions or bumps 708 act in combination with the spring loaded elements 104a-b such that only an individual single label exits the magazine 701 at a time. The magazine 701 is generally placed is close proximity with a transfer device and/or transfer member, as described with respect to the magazine 604 and elsewhere.

For example, referring to FIG. 7C, the magazine 604 is shown orientated in close proximity to a series of rollers 1807a-1 with a transfer device 1802 in line with the rollers 1807a-1. In this example, the label exits the magazine in response to a transfer member (not shown) as described with respect to FIGS. 6-7B. As the label exits the magazine, the label enters a series of concurrent nip rollers. In some examples, the rollers rotate in a direction as generally shown by arrow 1815. In this example, the rotation of the rollers 1807a-1 moves the label along in a direction generally shown by arrow 1814. The last pair of rollers, e.g., 1807k1, is located in close proximity to a transfer device 1802 having the belt 106. The close proximity of the transfer device 1802 to the rollers 1807a-1 ensures that as the individual label exits the rollers 1807a-1, the label contacts the belt 106. The vacuum of the belt 106 secures the front side of the label to the belt for further transport.

In some examples, the speed of the roller increases as the label progressed from the magazine 604 to the transfer device 1802. A variable roller speed along the series of rollers can accomplished with a high degree of controllability and continuous adjustability using servo or other motor control devices, or more simply using adjustable slip clutches on the rollers. The variable speed can accommodate removing labels from the magazine uses speeds different from label application speeds.

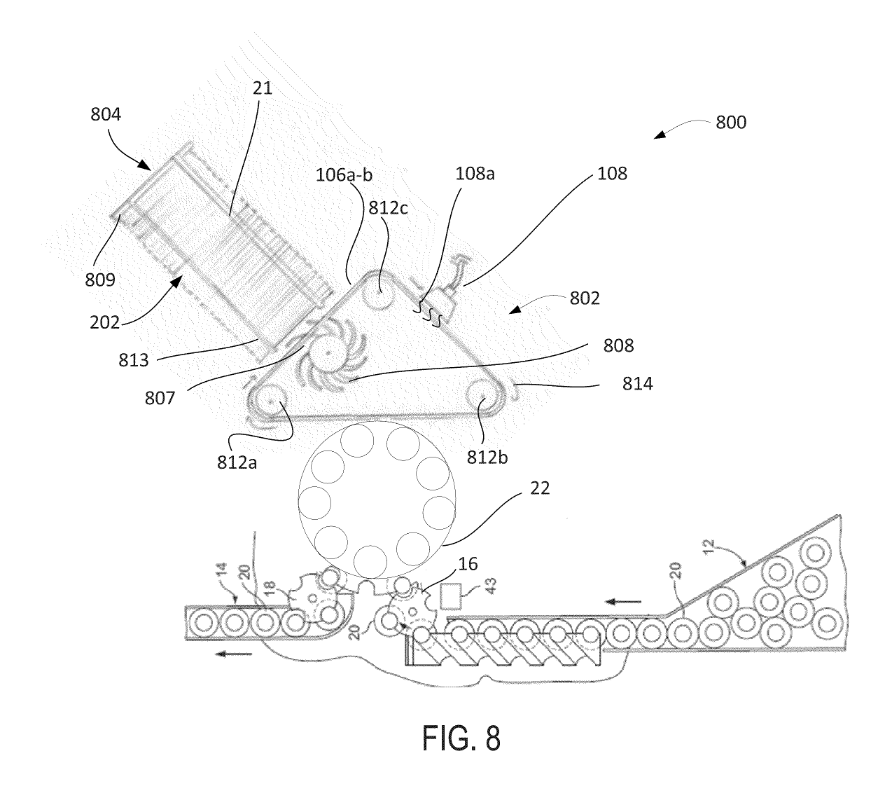

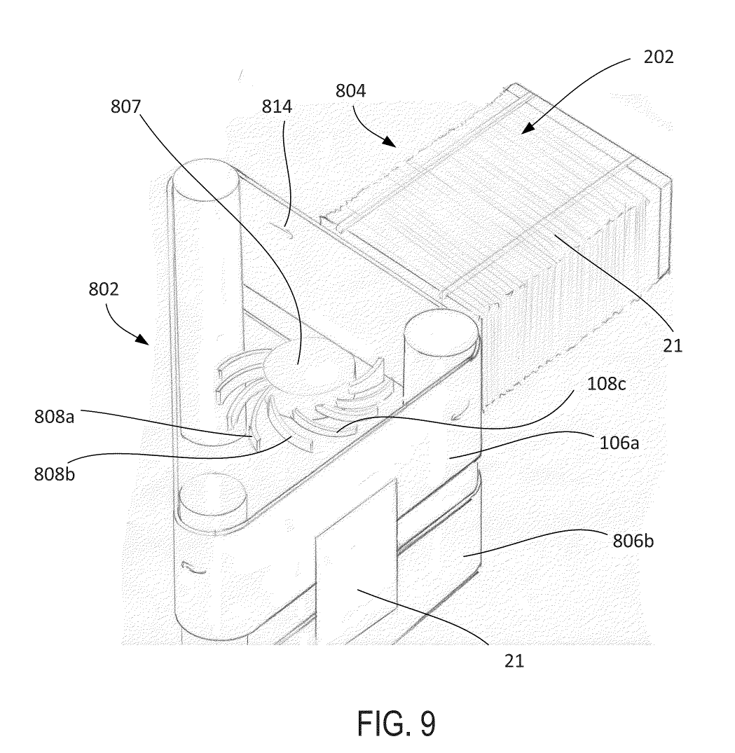

Referring to FIGS. 8 and 9, the apparatus 800 includes a transfer device 802 used to transfer a label from a magazine to the containers 20. More particularly, during use, the transfer device 802 uses a transfer member 807 having one or more extending arms to remove a non-activated label from the magazine 804 and a belt 106a-b to transfer the label through the adhesive activation station 108 to the surface of the containers 20. In some examples, the belt 106 includes a first portion 106a and a second portion 106b. In this example, the first portion 106a is orientated parallel to the second portion 106b with a gap between the two portions.

As described above, the belt 106 can be a porous belt that rotates around a vacuum chamber such that an object, e.g., a precut label, applied to a face of the belt is secured to the belt 106 during rotation of the belt 106 by a continued application of the vacuum.

As shown in FIGS. 8 and 9, a magazine 804, e.g., a dispensing magazine, retains a plurality of labels, e.g., a label stack 202, within the body of the magazine 804 between the dispensing end 813 and the loading end 809 such that the individual label, e.g., the front-most label 21e, from the label stack 202 is presented to a rotating transfer member 807 of a transfer device 802. The magazine 804 is configured to present individual label, e.g., the front-most label 21e, from the label stack 202 to the rotating transfer member 807. In some examples, one or more labels are canted at an angle substantially parallel to the longitudinal axis of the rotating transfer member 807. For example, the angle between the front of the label and the rotating transfer member 807 can be less than about 90°, e.g., less than about 80°, less than about 70°, less than about 60°, less than about 50°, less than about 40°, less than about 30°, less than about 20°, less than about 15°, less than about 10°, less than about 5°, and so forth. The rotating transfer member 807 includes one or more arms 808 extending outwards from the rotating transfer member. In some examples, the configuration of the rotating transfer member 807 and extending arms 808 is pinwheel-shaped. In some cases, the arms 808 are formed of a compliant material. For example, the extending arms can include curved portions. In some examples, the arms 808 are formed of a material selected from Vinyl, Polyurethane, Nitrile, Silicone, or other soft rubber. The configuration of the rotating transfer member 807 and the compliancy of the arms 808 provide positive contact against the label. This contact actively controls the transfer of the label 21 between the magazine and the belt 106. In some examples, the exerted positive control is adjusted by appropriately combining stiffness, friction, number of arms, and relative position of the of the arms to the front-most label in view of the application.

The arms 808a-b are configured to pass through the openings between the belt portions 106a-b to contact the labels 21 in the label stack 202. The contact between the arms 808a-b and the label 2l causes the label to exit the magazine 804. In this example, the magazine is in close proximity to the transfer device 802 and the belt 106 such that the vacuum of the belt 106 adheres and secures the front side of the label 21 to the belt 106 by a continued application of the vacuum to the label 21. As the label 21 is secured to the belt 106, the belt can begin rotating in a direction represented by, for example, the arrow 814.

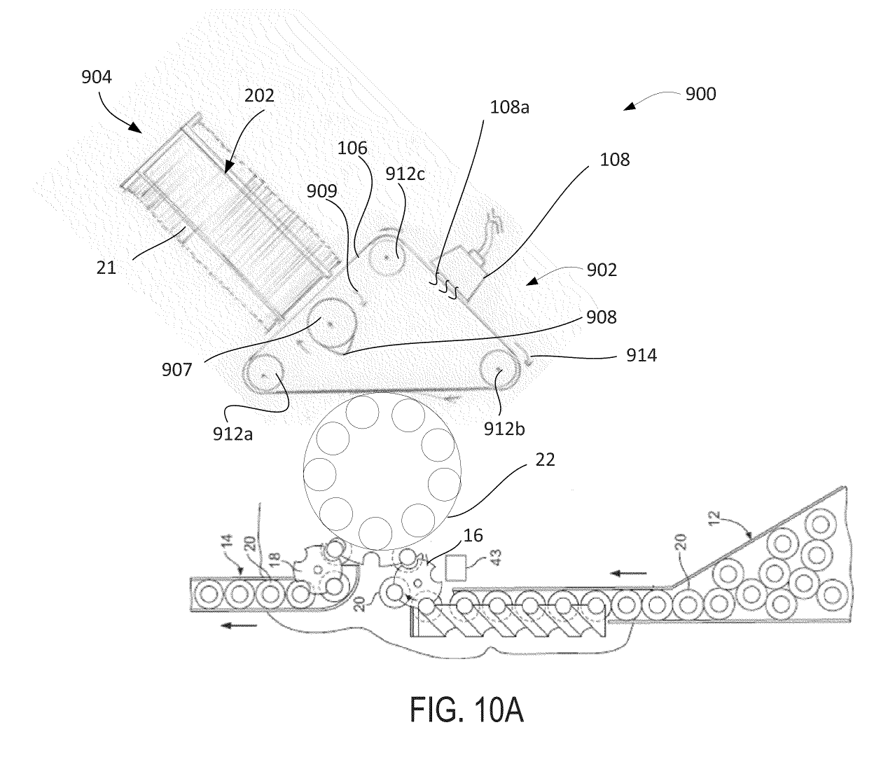

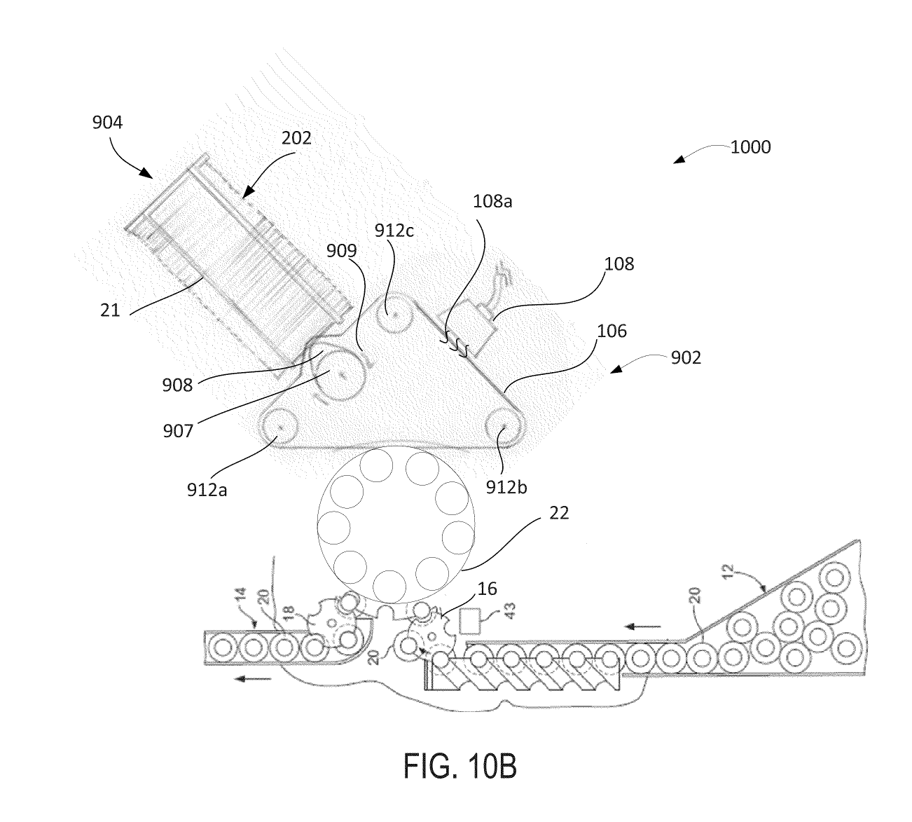

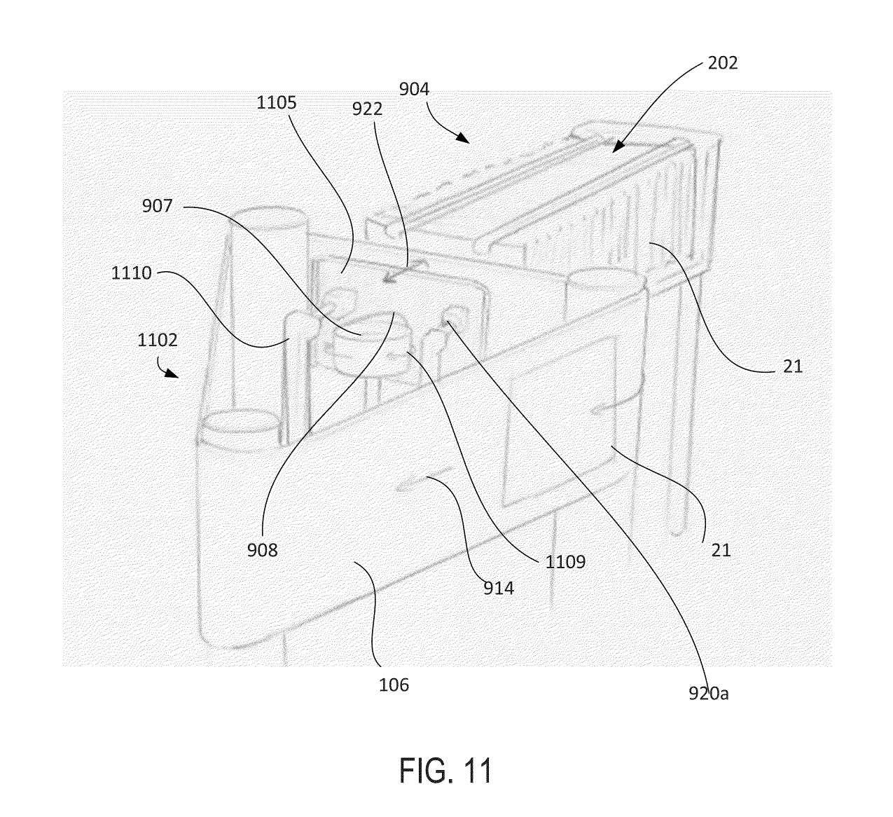

Referring to FIGS. 10A and 10B, the apparatus 900 includes a transfer device 902 used to transfer a label from a magazine 904, e.g., a dispensing magazine, to the containers 20. More particularly, during use, the transfer device 902 uses a rotating-transfer member 907 having one or more extending member 908, e.g., arms, protrusions, or nubs, to remove a non-activated label from the magazine 904 in combination with a belt 106a-b. The belt 106a-b also serves to transfer the label through the adhesive activation station 108 to the surface of the containers 20.

In some examples, the rotating-transfer member 907 is located in close proximity to the belt 106 and the magazine 904 with the belt 106 located between the rotating transfer member and the magazine.

As described above, the belt 106 can be a porous belt that rotates around a vacuum chamber such that an object, e.g., a precut label, applied to a face of the belt is secured to the belt 106 during rotation of the belt 106 by a continued application of the vacuum.

As shown in FIGS. 10A, 10B, 11, and 12, the magazine 904 retains a plurality of pre-cut individual labels, e.g., a label stack 202, within the body of the magazine 904 between the dispensing end 913 and the loading end 909 such that the individual label, e.g., the front-most label 21e, from the label stack 202 is presented to a rotating-transfer member 907 of a transfer device 902. The magazine 904 is configured to present the individual label, e.g., the front-most label 21e, from the label stack 202 to the rotating-transfer member 907. In some examples, one or more labels are canted at an angle substantially parallel to the longitudinal axis of the rotating-transfer member 907. For example, the angle between the front of the label the rotating-transfer member 907 can be less than about 90°, e.g., less than about 80°, less than about 70°, less than about 60°, less than about 50°, less than about 40°, less than about 30°, less than about 20°, less than about 15°, less than about 10°, less than about 5°, and so forth. The rotating-transfer member 907 includes one or more extending members 908 extending outwards from the rotating transfer member. In some examples, the configuration of the rotating-transfer member 907 and extending member 908 generally has triangular configuration. In some examples, the extending member extends about 3 mm to about 6 mm from the rotating-transfer member 907, e.g., about 3.1 mm, about 3.2 mm, about 3.5 mm, about 4 mm, about 4.1 mm, about 4.2 mm, about 4.5 mm, about 5 mm, about 5.1 mm, about 5.2 mm, about 5.6 mm, about 6 mm, and so forth. In some cases, the members 908 are formed of a compliant material. For example, the extending arms can include curved portions. In some examples, the members 908 are formed of a material selected from Vinyl, Polyurethane, Nitrile, Silicone, or other soft rubber.

The rotating-transfer member 907 is configured to come into contact with the belt 106 during rotation. Due to the proximity between the rotating transfer member and the belt 106 and the flexibility and/or compliance of the belt 106, the belt deforms away from the rotating transfer member 807 upon contact. In some examples, the belt deforms by about 3 mm to about 6 mm from the rotating-transfer member 907, e.g., about 3.1 mm, about 3.2 mm, about 3.5 mm, about 4 mm, about 4.1 mm, about 4.2 mm, about 4.5 mm, about 5 mm, about 5.1 mm, about 5.2 mm, about 5.6 mm, about 6 mm, and so forth. The close proximity of the transfer device 902 and the belt 106 to the magazine 904 ensures that the vacuum of the belt 106 adheres and secures the front side of the label 21 to the belt 106 by a continued application of the vacuum to the label 21. As the label 21 is secured to the belt 106, the belt can rotate in a direction represented by, for example, the arrow 914.

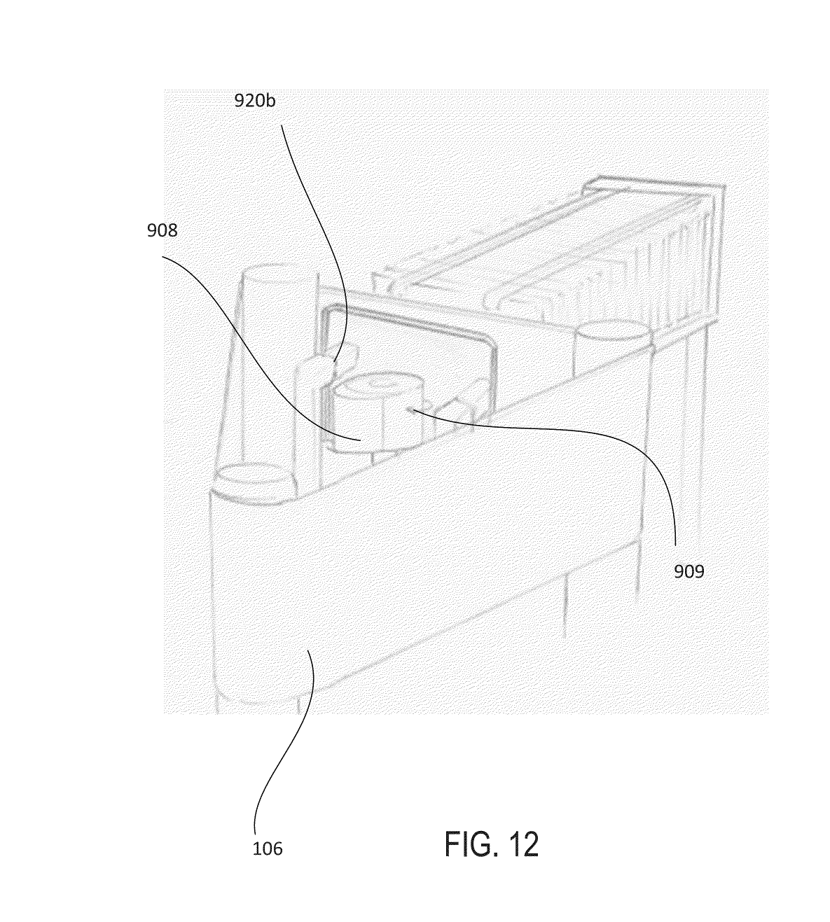

Referring to FIG. 11 and FIG. 12, in some examples, the rotating-transfer member 907 is configured to come into contact with a plate 1105 rather than directly with the belt 106. In this case, the rotating-transfer member 907 presses the plate 1105 along a direction generally shown by an arrow 922 and deforms a plate-shaped region of the belt 106 against the front-most label 21 in the magazine 904. Extending support members can be in an extended state 920a or a compressed state 920b based on the rotations of the rotating-transfer member 907. The close proximity of the transfer device 902 and the belt 106 to the magazine 904 ensures that the vacuum of the belt 106 adheres and secures the front side of the label 21 to the belt 106 by a continued application of the vacuum to the label 21. As the label 21 is secured to the belt 106, the belt can rotate in a direction represented by, for example, the arrow 914. In this example, the use of the plate 1105 provides a larger surface area of vacuum force for application against the label as compared with the one or more extending member 908 directly deforming the belt 106. In some examples, the plate is flat or curved.

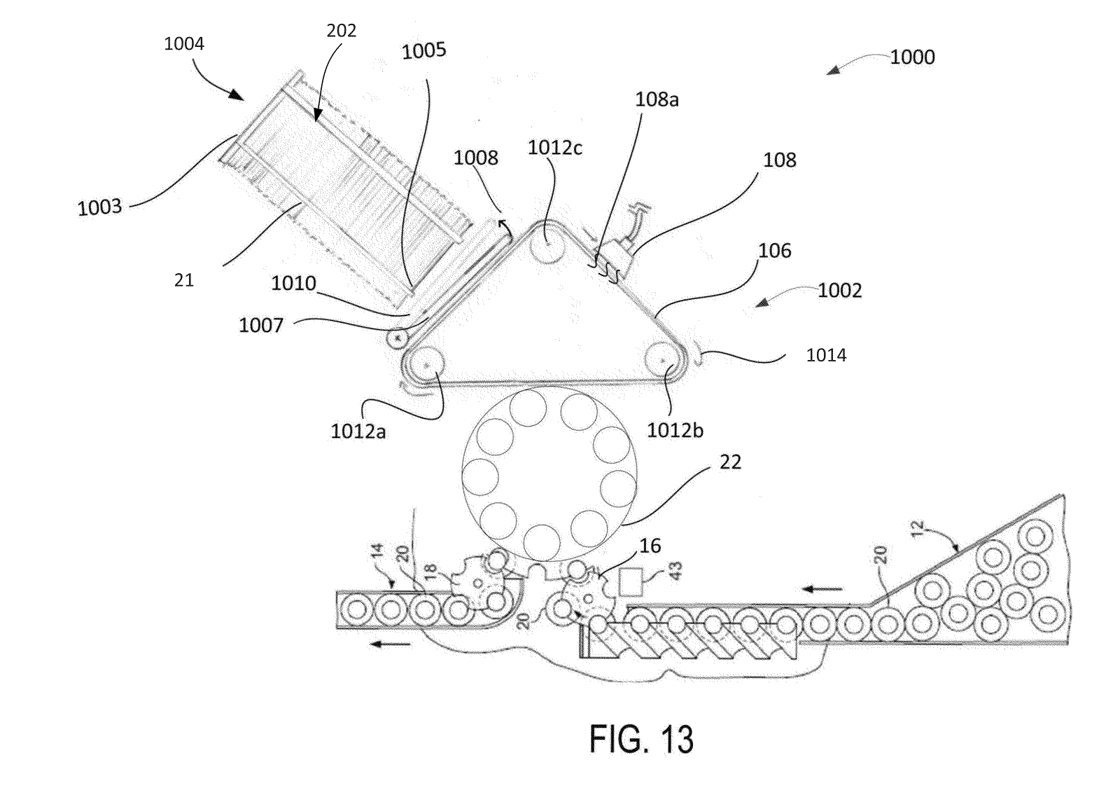

Referring to FIGS. 13-15, the apparatus 1000 includes an actuated transfer device 1007 to transfer a label from a magazine 1004, e.g., a dispensing magazine, to the transfer device 1002. The magazine 1004 retains a plurality of pre-cut individual labels, e.g., a label stack 202, between a dispensing end 1005 and a loading end 1003. The loading end 1003 includes a loading member 1022 configured to apply a force against the plurality of pre-cut individual labels, e.g., the label stack 202, such that the labels are pressed against the dispensing end 1005 of the magazine. The loading member is a spring-loaded paddle mounted to a rod or carriage that allows it to advance forward as labels are consumed, and can rotate or hinge to allow replacement labels to be installed. For example, as the labels are removed from the magazine 1004, the loading member 1022 applies a force against the label stack 202 such that the next label in the label stack 202 is re-positioned to replace the removed label. This process can be repeated until the label stack 202 is depleted.

More particularly, the apparatus 1000 includes an actuated transfer device 1007 having a top member 1014 and a bottom member 1016 to remove a non-activated label from the magazine 1004 in combination with a belt 106 to transfer a non-activated label from the actuated transfer device 1007 through the adhesive activation station 108 to the surface of the containers 20. The top member 1014 and/or the bottom member 1016 are separated by a slot 1020 and include at least one vacuum port 1018, e.g., at least 2, at least 3, at least 4, at least 5, at least 6, at least 7, and so forth, generally orientated towards the magazine 1004. In some examples, the height of the slot 1020 corresponds to about 99% of the label height, e.g., about 96%, about 94%, about 92%, about 90%, about 80%, about 70%, about 60%, about 50%, about 40%, about 30%, about 20%, about 10%, and so forth. In other examples, the length of the slot corresponds to about of the label length, e.g., about 99%, about 96%, about 94%, about 92%, about 90%, about 80%, about 70%, about 60%, about 50%, about 40%, about 30%, about 20%, about 10%, and so forth. In this example, the height of the belt 106 is less than the height of the height of the slot 1020, e.g., less than about 99% of the label height, e.g., less than about 96%, less than about 94%, less than about 92%, less than about 90%, less than about 80%, less than about 70%, less than about 60%, less than about 50%, less than about 40%, less than about 30%, less than about 20%, less than about 10%, and so forth.

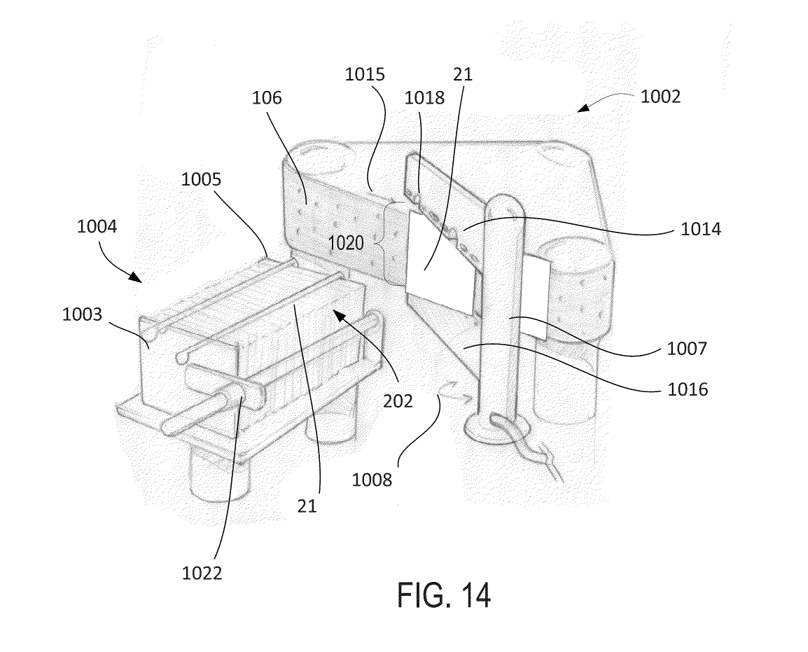

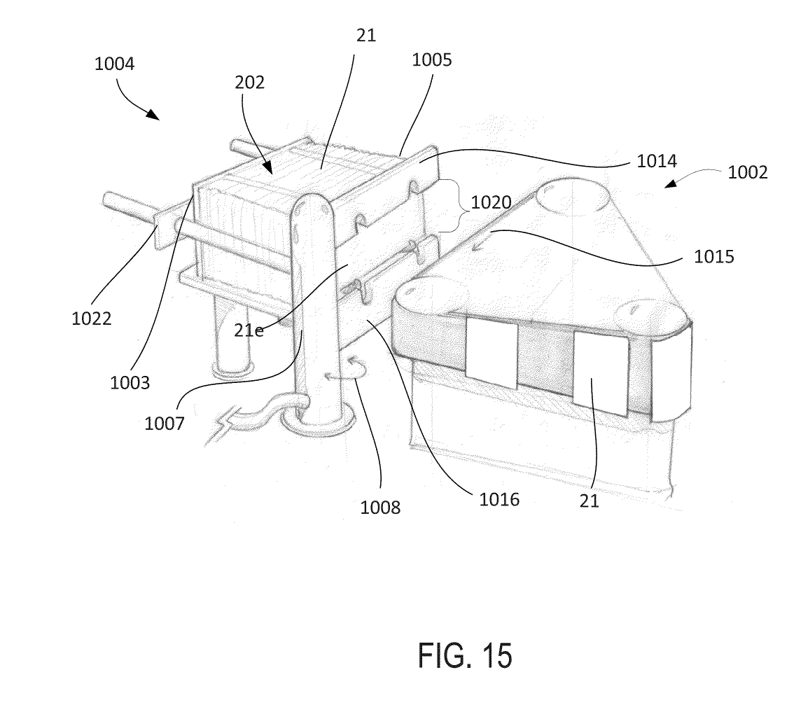

In some examples, the actuated transfer device 1007 is activated and travels, e.g., pivots, along a direction represented by, for example, the arrow 1008 from a first position (as primarily shown in FIG. 15) through second position 1010 to a transfer position (as primarily shown in FIG. 14). In the first position, the top member 1014 and bottom member 1016 contact the top and bottom edges of the individual label, e.g., the front-most label 21e, from the label stack 202. The at least one vacuum port 1018 is activated and a vacuum is applied against the top and bottom edges of the individual label, e.g., the front-most label 21e, from the label stack 202 such that the actuated transfer device 1007 adheres and secures the front side of the label 21 to the top member 1014 and/or bottom member 1016 by a continued application of the vacuum to the label 21. As the actuated transfer device 1007 moves through the second position 1010, the label 21 is released from the magazine 1002. In other examples, the activation of the vacuum along the top member 1014 and/or the bottom member 1016 causes the magazine 1002 to release the label.

As the actuated transfer device 1007 moves through the second position 1010 to a transfer position (referring to FIG. 14), the top member 1014 and bottom member 1016 straddle the belt 106, and the label 21 is released from the vacuum applied by the top member 1014 and/or the bottom member 1016. As discussed above, the height of the slot 1020 is greater than the height of the belt 106 such that the top member 1014 and/or bottom member 1016 avoids contact with the belt 106 during the movement of the actuated transfer device 1007. In some examples, the vacuum of the belt 106 is greater than the vacuum of the top member 1014 and/or bottom member 1016. For example the vacuum of the belt 106 is about 105% greater than the vacuum of the top member 1014 and/or bottom member 1016, e.g., about 110%, about 115%, about 120%, 125%, and so forth. In other examples, the vacuum of the top member 1014 and/or bottom member 1016 is briefly discontinued as the label secured to the top member 1014 and/or bottom member 1016 contacts the belt 106. As described elsewhere, the label can be secured to the belt 106, the belt can begin rotating in a direction represented by, for example, the arrow 1015 through the adhesive activation station 108 to the surface of the containers 20.

In some examples, a motor causes the movement of the actuated transfer device 1007. For example, the motorized arm could be an air cylinder or an electric actuator. The frequency of this actuation can be configured to provide an adjustable and/or desired rate of labels based on the number and/or rate of containers to be labeled and/or for improved accuracy of placement on the belt 106.

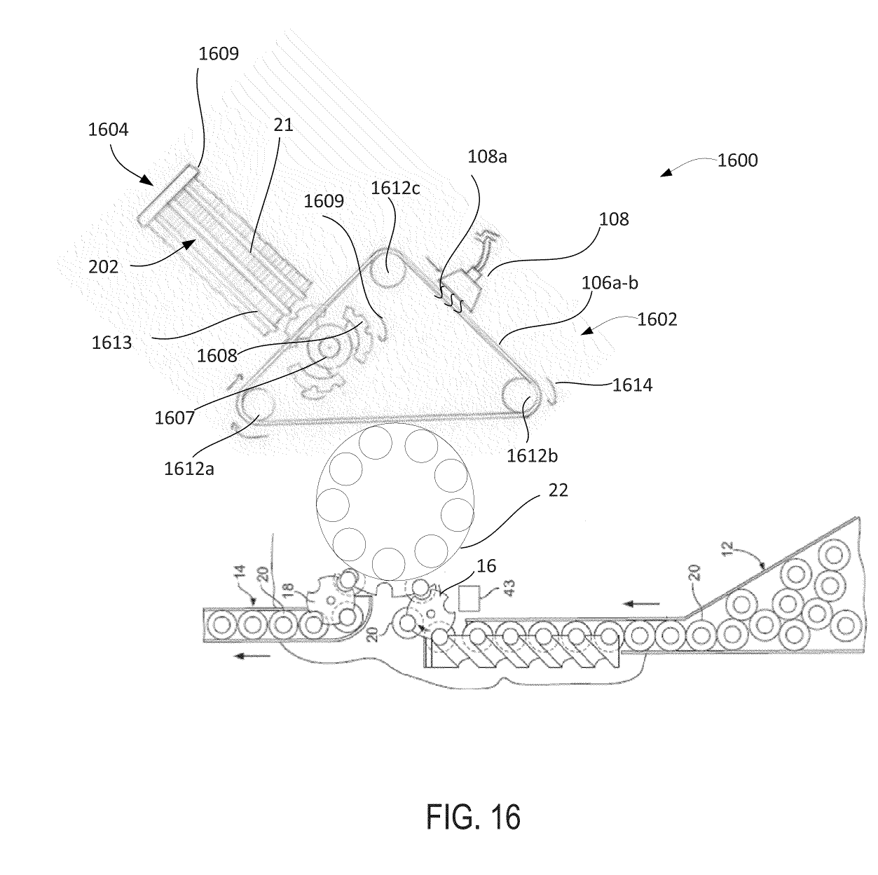

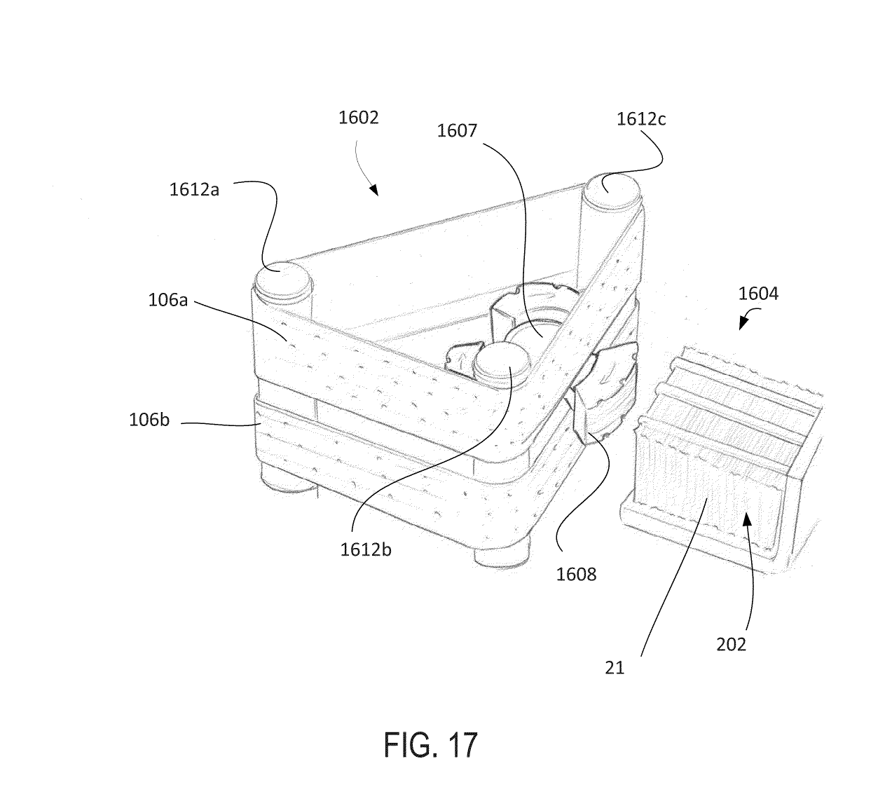

Referring to FIGS. 16-17 the apparatus 1600 includes a transfer device 1602 used to transfer a label from a magazine to the containers 20. More particularly, during use, the transfer device 1602 uses a rotating transfer member 1607 having one or more extending arms to remove a non-activated label from the magazine 1604 and a belt 106a-b to transfer the label through the adhesive activation station 108 to the surface of the containers 20. In some examples, the belt 106 includes a first portion 106a and a second portion 106b. In this example, the first portion 106a is orientated parallel to the second portion 106b with a gap between the two portions.

As described above, the belt 106 can be a porous belt that rotates around a vacuum chamber such that an object, e.g., a precut label, applied to a face of the belt is secured to the belt 106 during rotation of the belt 106 by a continued application of the vacuum.

As shown in FIGS. 16-17, a magazine 1604, e.g., a dispensing magazine, retains a plurality of labels, e.g., a label stack 202, within the body of the magazine 1604 between the dispensing end 813 and the loading end 1613 such that the individual label, e.g., the front-most label 21e, from the label stack 202 is presented to a rotating transfer member 1607 of a transfer device 1602. The magazine 1604 is configured to present the individual label, e.g., the front-most label 21e, from the label stack 202 to the rotating transfer member 1607. In some examples, one or more labels are canted at an angle substantially parallel to the longitudinal axis of the rotating transfer member 807. For example, the angle between the front of the label and the rotating transfer member 807 can be less than about 90°, e.g., less than about 80°, less than about 70°, less than about 60°, less than about 50°, less than about 40°, less than about 30°, less than about 20°, less than about 15°, less than about 10°, less than about 5°, and so forth. The rotating transfer member 1607 includes one or more pallets 1608 extending outwards from the rotating transfer member 1607. In some examples, the configuration of the rotating transfer member 1607 and the pallets 1608 includes a hub shaped central portion with multiple, e.g., 1, 2, 3, 4, or 5 extending pallets. In some cases, the pallets 1608 are vacuum-based pallets. For example, the pallets 1608 can includes multiple openings, in communication with a vacuum chamber, such that an object, e.g., a precut label, applied to the face of the pallet 1608 is secured to the belt pallet during rotation of the pallet 1608 by a continued application of the vacuum. While, in at least some of the examples described herein, the pallets include a suction supply mechanism provided along the pallet 1608, e.g., vacuum generators along the backside of the pallet, the vacuum generator can be located remotely from the pallet. For example, the vacuum generator can be located at a distance from the rotating platform or turret 22. In some examples, the pallets 1608 includes one or more valves that are each with associated with a particular one of the multiple openings, to selectively control communication of suction to a selected subset of the multiple openings based on the size of the label.

The pallets 1608 are configured to pass through the openings between the belt portions 106a-b to contact the front-most label 21 in the label stack 202. The contact between the pallets 1608a-b and the label 2l causes the label 21 to adhere to the pallet 1608 due to the vacuum. In this example, the magazine is in close proximity to the transfer device 1602 and the belt 106 such that the vacuum of the belt 106 adheres and secures the front side of the label 21 to the belt 106 by a continued application of the vacuum to the label 21 before the pallet rotates through the opening completely. In some examples, the vacuum of the belt 106 is greater than the vacuum of the pallets 1608. For example the vacuum of the belt 106 is about 105% greater than the vacuum of the pallets 1608, e.g., about 110%, about 115%, about 120%, 125%, and so forth. In other examples, the vacuum of the pallets 1608 is briefly discontinued as the label secured to the pallet 1608 comes into contact with the belt 106. As described elsewhere, the label can be secured to the belt 106, the belt can begin rotating in a direction represented by, for example, the arrow 1614 through the adhesive activation station 108 to the surface of the containers 20.

From the foregoing description, it will be apparent that there has been provided an improvement to an automated labeling machine for use with labels having fluid activatable adhesive. Variations and modifications in the herein described improvement, method, or system with machine, will undoubtedly suggest themselves to those skilled in the art. Accordingly, the foregoing description should be taken as illustrative and not in a limiting sense.

1. An apparatus for use with labeling machinery comprising
(a) a dispensing magazine for retaining a plurality of individual labels in a stack, the dispensing magazine including:
(1) a dispensing end configured to dispense the individual labels, the individual labels including a back surface having a fluid activatable adhesive that is non-tacky until activated and a front surface opposing the back surface, and
(2) a loading end configured to apply a force against the plurality of individual labels in the stack,
(b) a first rotating transfer member rotated in close proximity to the individual labels and including at least one belt thereon, the at least one belt having multiple openings for communication of suction to enable the transfer member to receive and releasably secure the front of the labels onto the at least one belt, and
(c) an adhesive activation station aligned with at least a portion of the rotating transfer member configured to apply to the back surface a fluid to activate the adhesive to become tacky along the back surface of the label.

2. The apparatus of claim 1, wherein the first rotating transfer member further comprises one or more valves, each of the valves being associated with a particular one of the multiple openings, to selectively control communication of suction to a selected subset of the multiple openings based on the size of the label.

3. The apparatus of claim 1, further comprising a container-handling device for receiving containers at an inlet, rotating the containers through a label application station, and directing the containers with the labels applied thereon to an outlet.

4. The apparatus of claim 1, further comprising an actuating transfer member connected to the dispensing end including a rotating end portion configured to contact the front surface of the individual labels and configured to move from a first position to a second position.

5. The apparatus of claim 4, wherein the movement of the actuating transfer member from a first position to a second position is configured to release the individual label from the dispensing end.

6. The apparatus of claim 1, wherein the dispensing magazine further comprises paddle members attached to the loading end and configured to apply a force against the stack such that the stack assumes a bowed configuration and an edge of the label is released from the dispensing end.

7. The apparatus of claim 1, wherein the dispensing magazine is configured to partially restrain at least one of the individual labels such that at least one edge of the label is free of the dispensing magazine.

8. The apparatus of claim 7, wherein the dispensing end further comprises a moveable retaining member, wherein the movement of the retaining member is configured to release at least one edge of the label.

9. (canceled)

10. The apparatus of claim 1, further comprising a second rotating transfer element connected to the dispensing end being rotated in close proximity with the individual label, wherein a rotation of the second rotating member is configured to release the individual label from the dispensing end.

11. (canceled)

12. The apparatus of claim 10, further comprising a plurality of rollers disposed between the first rotating transfer element and the dispensing magazine.

13. An apparatus for use with labeling machinery comprising
(a) a dispensing magazine for retaining a plurality of individual labels in a stack, the dispensing magazine including:
(1) a dispensing end configured to dispense the individual labels, the individual labels including a back surface having a fluid activatable adhesive that is non-tacky until activated and a front surface opposing the back surface, and
(2) a loading end configured to apply a force against the plurality of individual labels in the stack,
(b) an actuating transfer member in close proximity to the individual labels and configured to move from a first position to a second position, wherein the actuating transfer member is configured to contact the front surface of the individual labels at the second position, wherein the actuating transfer member includes:
(1) at least one belt thereon, the at least one belt having multiple openings for communication of suction to enable the actuating transfer member to receive and releasably secure the front surface of one of the labels onto the at least one belt at the second position,
(c) a rotating transfer member positionable with respect to the actuating transfer member to receive the individual labels from the actuating transfer member, in which the rotating transfer member includes at least one belt thereon including multiple openings for communication of suction to enable the rotating transfer member to receive and releasably secure the front surface of the individual labels onto the at least one belt, and
(d) an adhesive activation station aligned with at least a portion of the rotating transfer member configured to apply to the back surface a fluid to activate the adhesive to become tacky along the back surface of the label.

14. (canceled)

15. The apparatus of claim 13, wherein any of the rotating transfer member and the actuating transfer member further comprise one or more valves, each of the valves being associated with a particular one of the multiple openings, to selectively control communication of suction to a selected subset of the multiple openings based on the size of the label.

16. The apparatus of claim 13, wherein the movement of the actuating transfer member from a first position to a second position is configured to release the individual label from the dispensing end.

17. (canceled)

18. (canceled)

19. The apparatus of claim 13, wherein the actuating transfer member is configured to contact the rotating transfer member at the first position and the second position.

20. The apparatus of claim 19, wherein the at least one belt of the actuating transfer member and the at least one belt of the rotating transfer member are configured to form a continuous belt path.

21. An apparatus for use with labeling machinery comprising
(a) a dispensing magazine for retaining a plurality of individual labels in a stack, the dispensing magazine including:
(1) a dispensing end configured to dispense the individual labels, the individual labels including a back surface having a fluid activatable adhesive that is non-tacky until activated and a front surface opposing the back surface, and
(2) a loading end configured to apply a force against the plurality of individual labels in the stack,
(b) a first rotating transfer member positionable with respect to the dispensing end to receive the dispensed individual labels, in which the first rotating transfer member includes at least one belt thereon including multiple openings for communication of suction to enable the first rotating transfer member to receive and releasably secure the front surface of the individual labels onto the at least one belt,
(c) a second rotating transfer member in close proximity to the first rotating transfer member and including one or more arms extending from the perimeter of the first rotating member, and
(d) an adhesive activation station aligned with at least a portion of the second rotating transfer member configured to apply to the back surface a fluid to activate the adhesive to become tacky along the back surface of the label.

22. (canceled)

23. The apparatus of claim 21, wherein any of the second rotating transfer member and the first rotating transfer member further comprises one or more valves, each of the valves being associated with a particular one of the multiple openings, to selectively control communication of suction to a selected subset of the multiple openings based on the size of the label.

24. The apparatus of claim 21, wherein the one or more arms are rotatable to contact the individual labels.

25. The apparatus of claim 21, wherein the first rotating transfer member comprises two or more belts configured with a gap there between, wherein the one or more arms are rotatable to contact the individual labels through the gap.

26. (canceled)

27. The apparatus of claim 25, wherein the one or more arms comprise multiple openings for communication of suction to enable the second rotating transfer member to receive and releasably secure the front surface of the individual labels onto the one or more arms.

28. The apparatus of claim 21, wherein the one or more arms comprise a Vinyl, Polyurethane, Nitrile, Silicone, or other soft rubber material.

29. (canceled)

30. The apparatus of claim 21, wherein the one or more arms are arranged in a pinwheel configuration.

31. (canceled)

32. The apparatus of claim 21, wherein the one or more arms are rotatable to deform the first rotating transfer member into contact with the individual labels.

33. The apparatus of claim 21, further comprising a plate disposed between the first rotating transfer member and the second rotating transfer member, wherein the one or more arms are rotatable to contact the plate such that the plate deforms the first rotating transfer member into contact with the individual labels.

34. (canceled)

35. The apparatus of claim 33, wherein the plate is flat.

36. The apparatus of claim 33, wherein the plate is contoured.

37. An apparatus for use with rotary and inline labeling machinery comprising
(a) a dispensing magazine for retaining a plurality of individual discrete labels in a stack, the dispensing magazine including:
(1) a dispensing end configured to dispense the individual labels, the individual labels including a back surface having a fluid activatable adhesive that is non-tacky until activated and a front surface opposing the back surface, and
(2) a loading end configured to apply a force against the plurality of individual labels in the stack that allows for loading during uninterrupted dispensing from the dispensing end; and
(b) one or more first rotating transfer members in close proximity to the individual activatable labels configured to:
(1) remove the individual label from the dispensing magazine,
(2) present the back surface the individual label to an adhesive activation station, wherein the adhesive activation station is configured to apply a non-adhesive activating fluid to the back surface, and
(3) transfer the individual label to a second rotary transfer member or to a surface of a container.

38. The apparatus of claim 37, wherein the non-adhesive activating fluid is a solvent.

39. The apparatus of claim 37, wherein the individual label is removed from the dispensing magazine without the use of a viscous adhesive material.

40. The apparatus of claim 37, wherein the second rotary transfer member is configured to transfer the individual label through a label application station.
